(19) United States
(12) Patent Application Publication
(10) Pub. No.: US 2024/0422493 A1
(43) Pub. Date: Dec. 19, 2024

(54) DEVICE AND METHOD FOR RERECORDING AN EXISTING AUDIO SAMPLE

(71) Applicant: Kaetel Systems GmbH, München (DE)

(72) Inventor: Klaus KAETEL, München (DE)

(73) Assignee: Kaetel Systems GmbH, München (DE)

(21) Appl. No.: 18/823,452

(22) Filed: Sep. 3, 2024

Related U.S. Application Data
(63) Continuation of application No. PCT/EP2023/055268, filed on Mar. 2, 2023.

(30) Foreign Application Priority Data
Mar. 3, 2022 (EP) 22159907.9

(51) Int. Cl. H04S 3/00; G06F 3/16; G11B 27/036; H04R 3/00; H04R 5/02; H04R 5/027; H04S 7/00

(52) U.S. Cl. CPC H04S 3/008; G06F 3/162; G11B 27/036; H04R 3/005; H04R 5/02; H04R 5/027; H04S 7/302; H04S 2400/01; H04S 2400/11; H04S 2400/15

(57) ABSTRACT

An apparatus for re-recording an existing audio piece with a first number of channels includes: a loudspeaker arrangement for reproducing the first number of channels with a first number of loudspeaker systems in a reproduction space, wherein the first number is 1 or larger than 1, and wherein the one loudspeaker system or the loudspeaker systems of the first number of loudspeaker systems is/are configured to generate, for each channel of the first number of channels, a translation sound field and a rotation sound field in the reproduction space; a microphone arrangement with a second number of microphone systems arranged at different microphone positions in the reproduction space, wherein each microphone system of the second number of microphone systems is configured to capture a pressure signal and additionally a directional differential signal; and a recording or output interface.

### CROSS-REFERENCE TO RELATED APPLICATIONS

This application is a continuation of copending International Application No. PCT/EP2023/055268, filed Mar. 2, 2023, which is incorporated herein by reference in its entirety, and additionally claims priority from European Application No. 22159907.9, filed Mar. 3, 2022, which is also incorporated herein by reference in its entirety.

The present invention relates to the reproduction and recording of audio signals and in particular to re-recording an existing audio piece, which is also referred to as reamping.

### BACKGROUND OF THE INVENTION

Typically, acoustic scenes are recorded using a set of microphones. Each microphone outputs a microphone signal. For example, 25 microphones may be used for an audio scene of an orchestra. A sound engineer then mixes the 25 microphone output signals, e.g., into a standard format such as a stereo format, a 5.1 format, a 7.1 format, a 7.2 format, or any other corresponding format. In case of a stereo format, e.g., the sound engineer or an automatic mixing process generates two stereo channels. In the case of a 5.1 format, mixing results in five channels and one subwoofer channel. Analogously, in case of a 7.2 format, e.g., mixing results in seven channels and two subwoofer channels. If the audio scene is to be rendered in a reproduction environment, a mixing result is applied to electrodynamic loudspeakers. In a stereo reproduction scenario, there are two loudspeakers, the first loudspeaker receiving the first stereo channel, and the second loudspeaker receiving the second stereo channel. For example, in a 7.2 reproduction format, there are seven loudspeakers at predetermined positions, and two subwoofers, which can be placed relatively arbitrarily. The seven channels are applied to the corresponding loudspeakers, and the subwoofer channels are applied to the corresponding subwoofers.

The use of a single microphone arrangement when capturing audio signals, and the use of a single loudspeaker arrangement when reproducing the audio signals typically neglects the true nature of the sound sources. European patent EP 2692154 B1 describes a set for capturing and reproducing an audio scene, in which not only the translation but also the rotation and, in addition, the vibration is captured and reproduced. Thus, a sound scene is not only reproduced by a single capturing signal or a single mixed signal but by two capturing signals or two mixed signals that, on the one hand, are recorded simultaneously, and that, on the other hand, are reproduced simultaneously. This ensures that different emission characteristics of the audio scene are recorded compared to a standard recording, and are reproduced in a reproduction environment.

To this end, as is illustrated in the European patent, a set of microphones is placed between the acoustic scene and a (imaginary) listener space to capture the “conventional” or translation signal that is characterized by a high directionality, or high quality.

In addition, a second set of microphones is placed above or to the side of the acoustic scene to record a signal with lower quality, or lower directionality, that is intended to represent the rotation of the sound sources in contrast to the translation.

On the reproduction side, corresponding loudspeakers are placed at the typical standard positions, each of which has a omnidirectional arrangement to reproduce the rotation signal, and a directional arrangement to reproduce the “conventional” translatory sound signal. In addition, there is a subwoofer at each of the standard positions, or there is only a single subwoofer at an arbitrary location.

European patent EP 2692144 B1 discloses a loudspeaker for reproducing, on the one hand, the translatory audio signal and, on the other hand, the rotatory audio signal. Thus, the loudspeaker has, on the one hand, an arrangement that emits in an omnidirectional manner, and, on the other hand, an arrangement that emits in a directional manner.

European patent EP 2692151 B1 discloses an electret microphone that can be used for recording the omnidirectional or the directional signal.

European patent EP 3061262 B1 discloses earphones and a method for manufacturing earphones that generate both a translatory sound field and a rotatory sound field.

European patent application EP 3061266 A0, which is intended for grant, discloses earphones and a method for producing earphones configured to generate the “conventional” translatory sound signal by using a first transducer, and to generate the rotatory sound field by using a second transducer arranged perpendicular to the first transducer.

Recording and reproducing the rotatory sound field in addition to the translatory sound field leads to a significantly improved and therefore high-quality audio signal perception that almost conveys the impression of a live concert, even though the audio signal is reproduced by the loudspeaker or headphones or earphones.

This achieves a sound experience that can almost not be distinguished from the original sound scene in which the sound is not emitted by loudspeakers but by musical instruments or human voices. This is achieved by considering that the sound is emitted not only in a translatory manner but also in a rotary manner and possibly also in a vibrational manner, and is therefore to be recorded and reproduced accordingly.

There are several possibilities to synthetically generate, from already existing audio pieces in which only the translatory sound field has been recorded, a representation of the audio piece comprising both translatory components and rotatory components. Such methods are in WO2022218822A1 or in exemplarily disclosed in WO2022157251A2, WO2022253768A1.

To generated synthetic signals, stereo properties of existing audio pieces are used, and the difference between the left and the right stereo channel is used to synthetically reconstruct a rotation of the sound field.

However, this approach is limited to stereo signals and does not enable “reconstructing,” so to speak, a rotatory sound field for mono signals, for example.

In addition, the synthetic method is limited to the effect that it cannot be used for formats of higher order, i.e. formats comprising more than two channels (left and right) or more than three channels (left, middle, right) if high quality results are to be achieved.

In addition, it has been found that, even for a synthetic recovery of rotation information from stereo signals recorded in a translatory way, there are quality problems that, e.g., result from the fact that the differential signal of a stereo signal has strong power deviations that cause problems with respect to the synthetically generated rotation signal. Overall, thus, the synthetic generation of “enriched” audio pieces, i.e. audio pieces not only comprising translatory components but also describing the rotatory sound field and ultimately being able to generate the same by means of appropriate reproduction systems, provide a good possibility to improve existing audio content that is purely translatory. However, the qualities ultimately achievable for the full sound field with translatory sound on the one hand and rotatory sound on the other hand are limited in the synthetic generation.

### SUMMARY

According to an embodiment, an apparatus for re-recording an existing audio piece with a first number of channels may have: a loudspeaker arrangement for reproducing the first number of channels with a first number of loudspeaker systems in a reproduction space, wherein the first number is 1 or larger than 1, and wherein the one loudspeaker system or the loudspeaker systems of the first number of loudspeaker systems is/are configured to generate, for each channel of the first number of channels, a translation sound field and a rotation sound field in the reproduction space; a microphone arrangement with a second number of microphone systems arranged at different microphone positions in the reproduction space, wherein each microphone system of the second number of microphone systems is configured to capture a pressure signal and additionally a directional differential signal; and an interface for outputting or recording the pressure signal and the directional differential signal or a differential signal derived from the directional differential signal as a re-recorded audio piece.

According to another embodiment, a method for re-recording an existing audio piece with a first number of channels may have the steps of: reproducing the first number of channels with a first number of loudspeaker systems in a reproduction space, wherein the first number is 1 or larger than 1, or wherein the one loudspeaker system or the loudspeaker systems of the first number of loudspeaker systems is/are configured to generate, for each channel of the first number of channels, a translation sound field and a rotation sound field in the reproduction space; recording with a second number of microphone systems arranged at different microphone positions in the reproduction space, wherein each microphone system of the second number of microphone systems is configured to capture a pressure signal and additionally a directional differential signal; and outputting or recording the pressure signal and the directional differential signal or a differential signal derived from the directional differential signal as a re-recorded audio piece.

According to another embodiment, a re-recorded audio piece may have: a first pressure signal, a first directional differential signal, and a second directional differential signal for a first channel; and a second pressure signal, a third directional differential signal, and a fourth directional differential signal for a second channel.

The present invention is based on the finding that the reamping method is used for generating a high quality audio representation. In the reamping method or in re-recording an existing audio piece with one or several channels, i.e. a first number of channels, the audio piece is reproduced, i.e. with loudspeakers arranged at certain loudspeaker positions. If the existing audio piece only has a single mono channel, the loudspeaker for re-recording is arranged in the middle with respect to a listener position in a reproduction space (or reproduction room). If the existing audio piece has two channels, i.e. a left channel and a right channel, two different loudspeaker systems are arranged at the two positions on the left and the right. Analogously hereto, if the audio piece has three channels, i.e. a left channel, a middle channel, and a right channel, three loudspeaker systems are arranged at the positions left, middle, right in the reproduction space. However, as is the case in conventional reamping, the loudspeaker systems are not simple translatory loudspeakers, but they are loudspeaker systems that are able to generate a translation sound field and a rotation sound field in the reproduction space. To this end, the loudspeaker systems according to the invention are controlled (driven) with two different audio signals, i.e. one audio signal for the sound transducer system for generating the translation sound field and a further audio signal for the sound transducer system for the rotation sound field. According to the invention, both audio signals are generated by one and the same channel of the existing audio piece.

In order to obtain the re-recorded audio piece, according to the invention, individual microphone systems are arranged at the reproduction positions desired for a format of higher order, wherein said individual microphone systems are configured to capture an omnidirectional pressure signal and at least one directional differential signal for the position at which the respective microphone systems are arranged. The omnidirectional pressure signal represents the sound pressure and represents a typical mono signal or a typical one-channel signal of a multi-channel recording. In addition, the directional differential signal represents a component of the sound velocity at the microphone position. According to the invention, the sound velocity may be captured through different directional differential signals, wherein it is advantageous for a high-quality recording to separately record all three components of the sound velocity, i.e. the directional differential signal in the x direction and the directional differential signal in the y direction and the directional differential signal in the z direction.

The result is output or recorded by means of an interface so that a re-recorded audio piece is obtained that now has a number of channels equal to the number of microphone systems used, wherein each channel now no longer comprises an individual mono signal, as is the case in the existing audio piece, but, beside an omnidirectional audio signal, also one or several directional differential signals to describe the sound velocity at this position either approximately (in the case of only one directional differential signal or a summed-up differential signal) or particularly precisely in the case of three directional differential signals.

The method according to the invention and the corresponding apparatus for re-recording are characterized in that any formats for the audio pieces may be generated, wherein, according to the embodiment, additional microphone systems may be arranged accordingly at corresponding additional positions in the reproduction space.

A reproduction space comprising specific acoustics is used, which, in particular, if this information is still available, is either the same reproduction space in which the existing audio piece has been recorded, or which has similar acoustic properties or at least comparable acoustic properties as the reproduction space in which the existing audio piece has been recorded. This makes it possible to give new “life” to old recordings that are only available in mono or stereo, since, by means of the inventive loudspeaker systems, it is not just the translatory sound field that is generated in the reproduction space but also the rotatory sound field approximated with respect to the rotatory sound field that the artist also generated in the first recording of the existing audio piece in the reproduction space, however, that had not been recorded.

According to the invention, this “omission” in the past may be rectified even if the artist or the group of artists is no longer available.

Thus, it is possible to convert existing recordings that have been recorded without rotatory sound field components into a new particularly high quality format, wherein the special format is achievable by arranging corresponding microphone systems at corresponding positions needed by the special format.

In the case of re-recording a mono piece, two microphone systems for a stereo representation may be achieved, or, e.g., five microphone systems for a surround representation, or significantly higher order formats, e.g., a multichannel arrangement with 22 channels (or any subgroup thereof with less than 22 channels) according to ITU-R BS.2159-9 in a top layer, a middle layer, and a bottom layer, or any other selected arrangement of the different 25 loudspeakers according to ISO/IEC 23003:1. A further format is the Dolby Atmos format with seven loudspeakers in the middle layer and four or also six loudspeakers in the top layer. All of this may simply be achieved by not arranging reproduction loudspeakers in the corresponding reproduction positions of these formats, but by arranging microphone systems so as to respectively record signals at these positions, wherein said signals, when the re-recorded audio piece is to be reproduced at any point in time, represent the corresponding signals at the corresponding reproduction positions, and may be reproduced there by appropriate loudspeakers. However, this reproduction will not be carried out with simple translatory loudspeaker systems but with loudspeaker systems capable of generating a translatory sound field and a rotatory sound field, i.e. which are able to not only generate common mode signals but also differential mode signals.

### BRIEF DESCRIPTION OF THE DRAWINGS

Embodiments of the present invention will be detailed subsequently referring to the appended drawings, in which:

FIG. 1a shows an embodiment of the apparatus for re-recording an existing audio piece;

FIG. 1b shows a schematic illustration of the existing audio piece;

FIG. 1c shows a schematic illustration of the re-recorded audio piece;

FIG. 2 shows an illustration of the control of the individual loudspeakers of the different loudspeaker systems according to an embodiment;

FIG. 3 shows an illustration of the loudspeaker positions and the microphone system positions for a Dolby Atmos format with seven channels in the mid-layer and six channel in the top layer;

FIG. 4 shows a schematic overview of different loudspeaker positions and arrangement according to ISO/IEC 23003:1;

FIG. 5 shows a schematic illustration of the reproduction position of a 22.2 multichannel arrangement according to ITU-R BS.2159-9;

FIG. 6a shows a schematic illustration of the vertical positions in Dolby Atmos;

FIG. 6b shows a top view of the reproduction position of a Dolby Atmos 7.4 format;

FIG. 7 shows a schematic illustration of a loudspeaker system;

FIG. 8 shows a further embodiment of a loudspeaker system;

FIG. 9 shows an embodiment of the sound transducer system for emitting the rotation sound;

FIG. 10 shows a further embodiment of a loudspeaker system;

FIG. 11 shows a microphone system with two partial microphones;

FIG. 12 shows a microphone system with three partial microphones;

FIG. 13a shows a combiner for generating the directional differential signals;

FIG. 13b shows an individual combiner for a differential signal generation;

FIG. 13c shows a combiner according to an embodiment for the microphone system;

FIG. 14 shows a microphone system, or a microphone, according to an embodiment;

FIG. 15 shows an embodiment for generating a control signal for the left side or the right side of FIG. 2; and

FIG. 16 shows an embodiment for generating a control signal with two variably amplified differential mode signals for the first or left and the second or right differential mode signal feed.

### DETAILED DESCRIPTION OF THE INVENTION

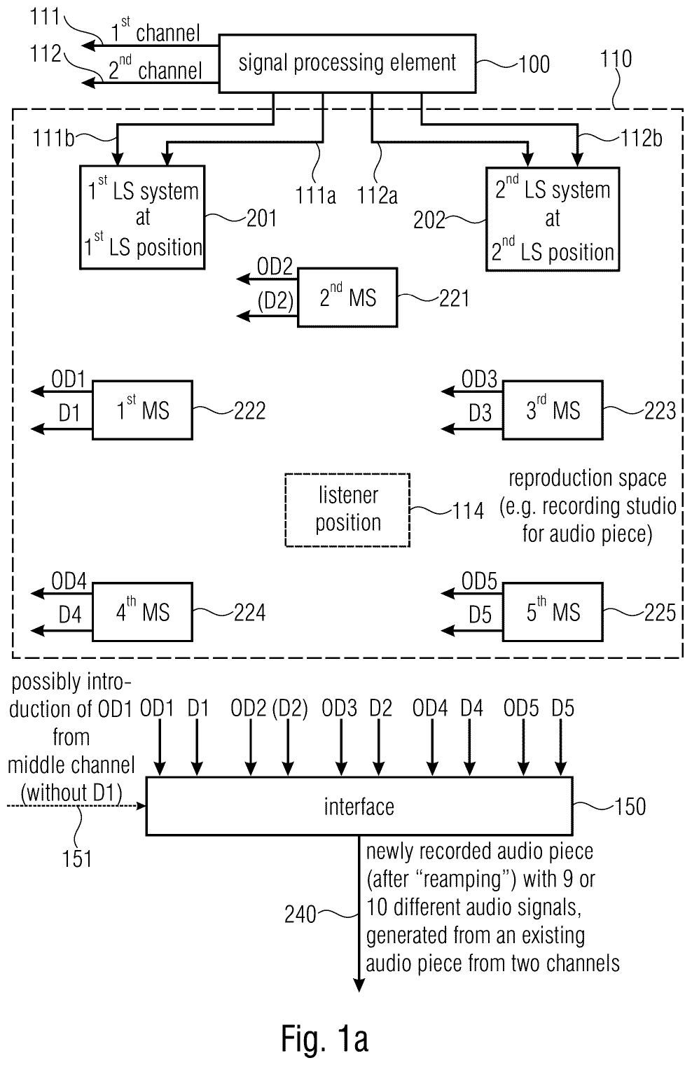

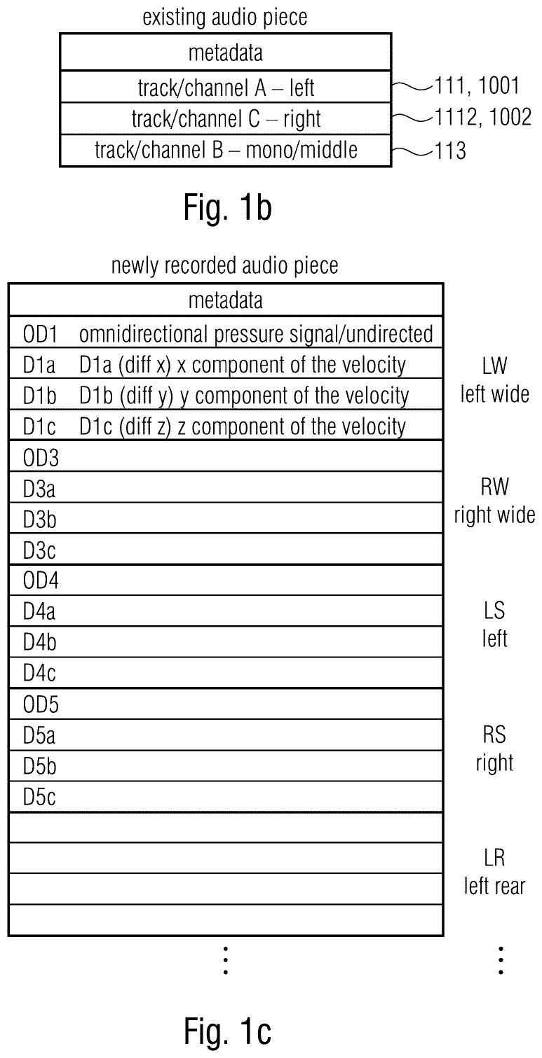

FIG. 1a shows an apparatus for re-recording (or newly recording) an existing audio piece with a first number of channels, wherein FIG. 1a exemplarily illustrates a first channel 111 and a second channel 112. The apparatus includes a loudspeaker arrangement for reproducing the first number of channels with a first number of loudspeaker systems in a reproduction space 110. In the embodiment shown in FIG. 1a, the loudspeaker arrangement includes a first loudspeaker system 201 at a first loudspeaker position, which is at the left position in the embodiment shown in FIG. 1a. A second loudspeaker system is shown at 202 and is arranged at a second loudspeaker position. Since the existing audio piece comprises two channels 111, 112, with the first channel being considered for the left loudspeaker system 201 and the second channel 112 being considered for the right loudspeaker system 202, only two loudspeaker systems are employed.

Each loudspeaker system is configured to generate a translation sound field and a rotation sound field for each channel 111, 112 of the first number of channels. To this end, each loudspeaker system includes two different sound transducer systems, i.e. one sound transducer system for generating the rotation sound field and a separate sound transducer system for generating the translation sound field. To this end, a signal processing element 100 is provided so as to generate two audio signals from each channel. The signal processing element 100 generates from the first channel 111 the first audio signal 111a for the translatory sound transducer system and the second audio signal 111b for the rotatory sound transducer system. Accordingly, the signal processing element 100 also generates from the second channel 112 a first audio signal 112a and a second audio signal 112b, wherein these audio signals are then supplied to the respectively different sound transducer systems of the second loudspeaker system.

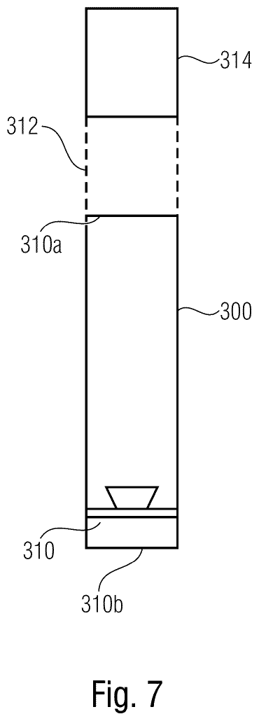

Even though embodiments for the loudspeaker systems that will be described in more detail on the basis of FIGS. 7 to 10 use fully separated sound transducer systems to generate the rotation sound field on the one hand and the translation sound field on the other hand, sound transducer systems with at least two loudspeakers that are both controlled with the common mode signal and the differential mode signal may alternatively be used so that these two loudspeakers together generate the translation sound field and the rotation sound field, as is exemplarily illustrated in international application WO2022218824A2, which is incorporated herein by reference in its entirety.

However, the use of separate systems makes it possible that the rotation sound field may be emitted almost omnidirectionally so that a particularly good omnidirectional, that is undirected, excitation of the rotation field may take place in the reproduction space even if the audio piece comprises only a single mono channel or is only a stereo signal with two stereo channels or is a 3-channel format.

Thus, the first number of channels may be one if the existing audio piece has only a single mono channel or when only a single channel is to be used for reamping. Alternatively, the existing audio piece may also have two or more channels so that the first number of channels may also be larger than 1.

Furthermore, the apparatus for re-recording also includes a microphone arrangement with a second number of microphone systems 221, 222, 223, 224, 225 arranged at different positions in the reproduction space. In particular, each microphone system of the second number of microphone systems is configured to capture both an omnidirectional pressure signal and a directional differential signal. The omnidirectional signal is indicated in FIG. 1a with OD, whereas the directional differential signal is indicated with D. The number that follows refers to the number of the microphone system through which the signals are captured.

In addition, the loudspeaker arrangement includes an interface 150 for outputting or recording the omnidirectional pressure signal and at least one directional differential signal for each of the microphone systems of the number of the second number of microphone systems so as to obtain the re-recorded audio piece 240 either in a recorded form or in an output form. In the embodiment shown in FIG. 1a, after reamping, the audio piece includes nine or ten different audio signals generated from an existing audio piece with two channels. In the embodiment shown in FIG. 1a, the second microphone system 221 is illustrated in the middle position. Depending on the implementation, it has been shown that this reproduction position is described well only by means the omnidirectional pressure signal, since, e.g., a loudspeaker or a singer essentially characterized by a direct sound generation and sound output is typically positioned at this location. Thus, the directional differential signal may be secondary at this position, and it may be omitted, as indicated in FIG. 1a with the brackets around the directional differential signal D2 at the input of the interface 150 or at the output of the second microphone 221.

Alternatively, the omnidirectional signal may also be generated by adding the first channel and the second channel, for example, and it may therefore be introduced separately, as is shown at 151. If neither the omnidirectional signal OD2 nor the directional differential signal D2 is needed by the microphone system 221 at the middle positon, the setup of a microphone system at this location may also be completely omitted so as to reduce the effort for reamping, or for re-recording. Then, the middle channel from the existing audio piece, if available, is added to the re-recorded audio piece or, if not available, is generated from the available left and right channels by means of downmixing, and the result of the downmixing is added to the re-recorded audio piece.

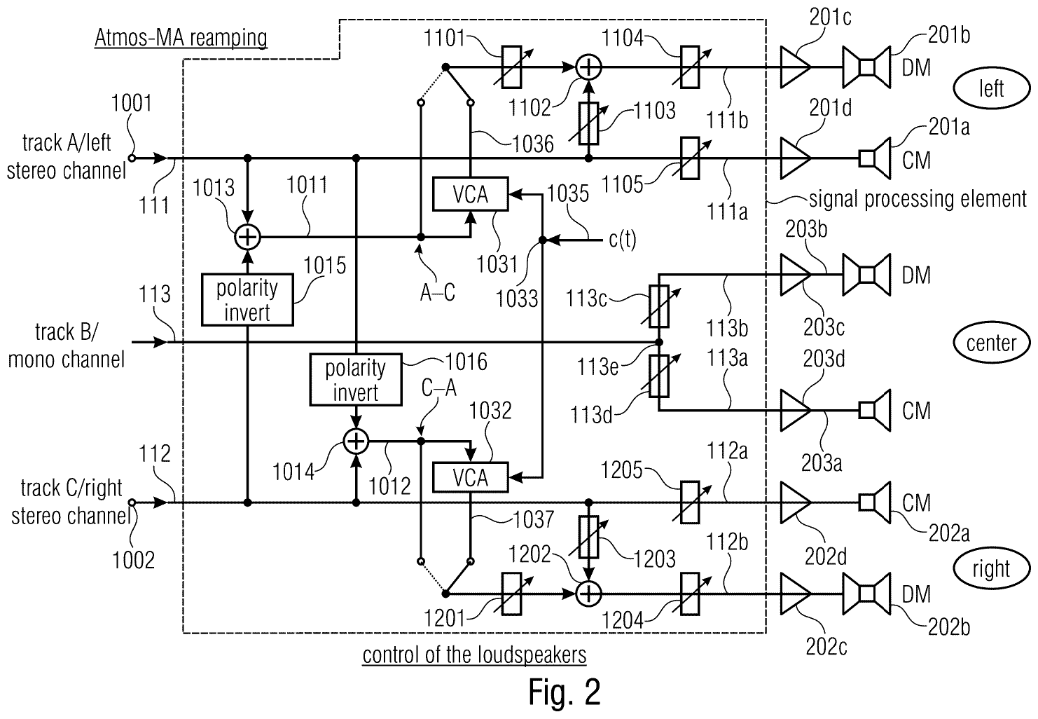

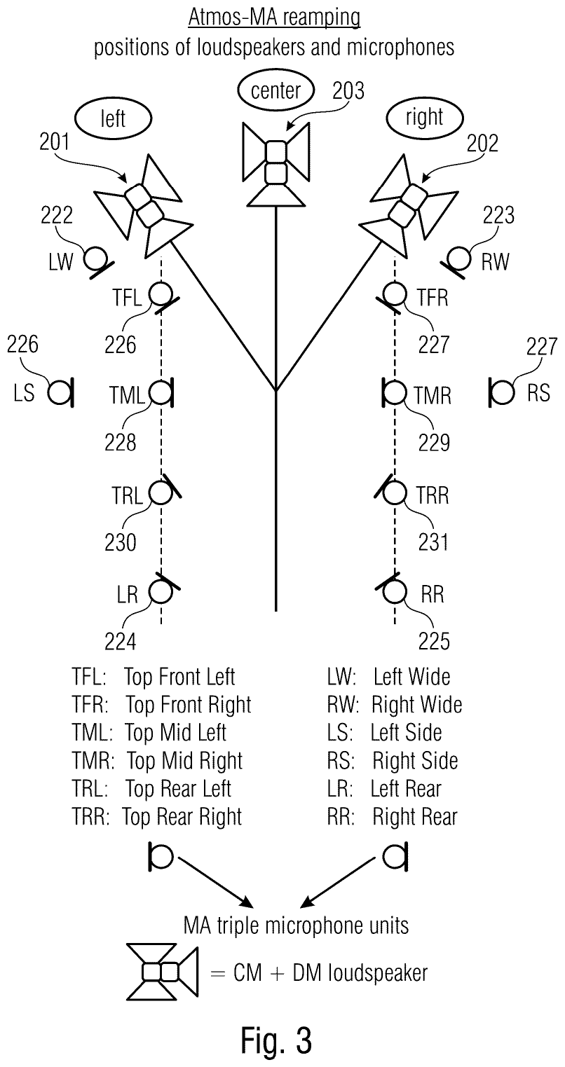

As will be illustrated with reference to FIG. 3, the use of the second microphone system 221 at the middle position will be omitted if a three-channel signal comprising a middle channel is to be re-recorded. Then, the channel, or the track B, is generated in the re-recorded audio piece from the original middle channel 113, as is illustrated in FIG. 2, and is introduced into the re-recorded audio piece via the introduction element 151 and the interface 150, without a recording with a microphone system actually having taken place. Obviously, however, according to the embodiment, a microphone system 221 may be set up at the middle position, as is shown in FIG. 1a, and the omnidirectional signal as well as the directional differential signal may be introduced into the re-recorded audio piece from this microphone system via the interface 150.

In principle, the reproduction space 110 may be any reproduction space, it does not necessarily have to be an enclosed space, but it simply has a defined spatial extension in which the loudspeaker systems and the microphone systems may be set up at certain positions. Thus, the space may also be a “free space” if the audio piece was a live concert, for example, i.e. it had not been recorded in a specific studio.

However, if the audio piece had been recorded in a studio, it is advantageous to use exactly the same studio as a reproduction space for re-recording again, since the rotation sound field that has been generated but not recorded in the first recording of the audio piece by the artist will now be recorded in addition, so to speak, by the inventive approach for re-recording and will be made available for a high quality audio reproduction.

FIG. 1b shows an illustration of an existing audio piece that will typically comprise certain metadata, and, in addition to the metadata, will have a left channel, or a left track A, a right track, or a right channel C, and a middle, or mono, channel B. The left channel is indicated with 111, or 1001. The right channel is indicated with 112 or 1002 and the middle channel is indicated with 1013.

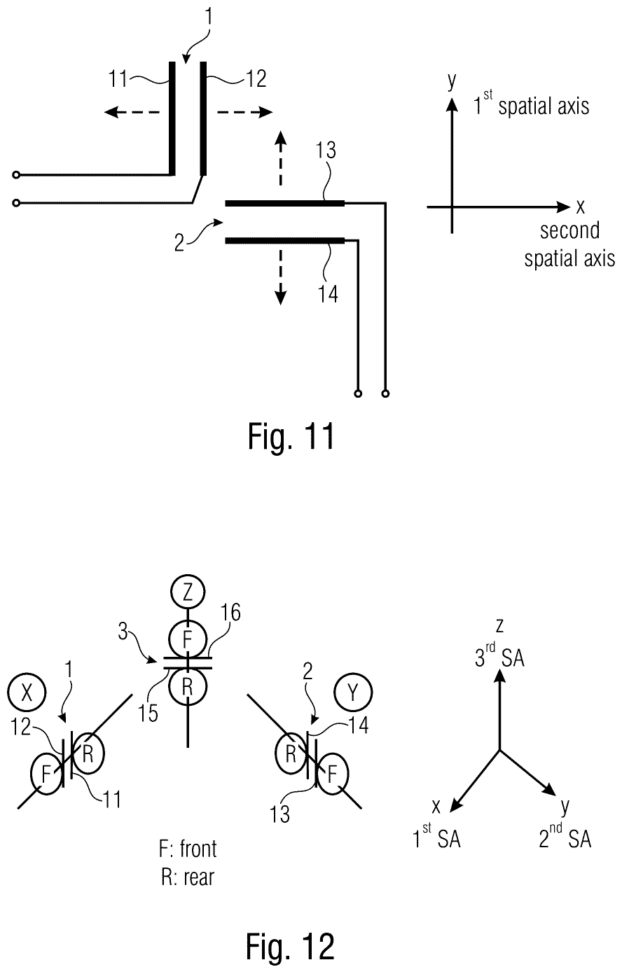

For comparison, FIG. 1c shows the re-recorded audio piece again comprising metadata that may now have a larger extent than the original metadata since the data associated with the metadata has now become significantly more enriched. In the exemplary scenario in FIG. 1c, which shows five reproduction positions left wide, right wide, left, right and left rear, the original three channels have already become 20 audio tracks, wherein a “channel”, e.g., the LW channel, consists of three individual channel signals, i.e. the omnidirectional pressure signal OD1, and the directional differential signal D1a in the x-direction, the directional differential signal D1b in the y-direction, and the directional differential signal D1c in the z-direction. The generation, or recording, of the these differential signals is subsequently illustrated in detail with reference to the detailed explanation of the microphone system in FIGS. 11 to 14.

Depending on the embodiment, a maximum, i.e. a maximum precise, representation of the sound velocity may be recorded explicitly by all three components x, y, z. However, certain “intermediate” representation may be used to reduce the transfer effort, or the size of the re-recorded audio piece. For example, only a single differential signal may be recorded and transferred, e.g. the largest of the three differential signals. Alternatively, the three differential signals may be added to generate and transfer an overall differential signal, e.g. by addition of D₁ₐ, D_{1b}, and D_{1c}. Alternatively, two differential signals, i.e. x, y or x, z, or y, z, may be added. Furthermore, any combinations are possible, e.g. only the transfer of the largest differential signal with respect to its power, e.g. in a frame, or in a certain time range, and optionally additionally the second largest signal or a sum of the two remaining directional components, etc. In any case, in contrast to the original audio piece, the re-recorded audio piece will have more “channels,” and each channel will, beside the omnidirectional pressure signal, include at least one directional differential signal being a differential signal that was actually measured, or a signal resulting from the combination, such as an addition, of measured differential signals. In any case, this differential signal will describe the sound velocity more or less precisely, and will enable, if the re-recorded audio piece is to be reproduced, controlling a corresponding differential mode transducer, i.e. a corresponding transducer for the generation of a rotation sound field. As described, the pressure signal is omnidirectional, however, depending on the microphone; it may also carry residuals of a directionality. However, it is a pressure signal, and, in contrast to the directional differential signals representing the sound velocity, it does not represent a direction of a vector field, but does only represent the omnidirectional pressure at the microphone position. It may be obtained in different ways, e.g. through addition of signals of microphone diaphragms, through its own pressure transducer, or through the addition of the two components of the diaphragms of a partial microphone, such as the partial microphone for the z direction.

The inventive concept is useful for an “up-scaling” to take place, i.e. for the second number of microphone systems being larger than the first number of channels. However, in principle, it is also possible to use, e.g., only one channel of an existing audio piece, and to control an inventive loudspeaker system with this channel, with an inventive microphone arranged at the middle positon next to the loudspeaker system or between the listener position 114 and the loudspeaker system, to obtain the re-recorded mono signal now including a directional differential signal in addition to an omnidirectional pressure signal. Thus, the second number may also be equal to the first number.

Further formats are the generation of a re-recorded audio piece with a stereo characteristic from an original audio piece with a mono characteristic or from an original stereo audio piece that did not have any rotation information. In addition, it is also possible to record an enriched, i.e. re-recorded, audio piece with three microphone systems from three original channels, said audio piece now again having three “channels”, wherein each channel now includes a directional differential signal or several directional differential signals in addition to a (omnidirectional) pressure signal.

FIG. 3 shows a specific embodiment of the arrangement of the loudspeaker systems and the microphone systems with respect to an example of re-recording for the Dolby Atmos format with the inventive loudspeaker systems of Molecular Acoustics (MA) and with the microphone systems of Molecular Acoustics (MA).

In particular, it shows a format comprising six reproduction positions and therefore positions for the inventive microphone systems, i.e. the positions 222, 223, 224, 225, 226, 227 in the middle layer. In addition, six further reproduction positions and therefore microphone system positions 226, 227, 228, 229, 230, 231 are shown in the top layer. The resulting re-recorded signal then has the enriched “channels” for the microphone positions 222 to 231 and additionally it has the middle signal that, however, is extracted directly from the existing audio piece and is added to the signal, as is shown at 151 in FIG. 1a. In the embodiment shown in FIG. 3, if the omnidirectional signal and three directional differential signals are recorded for each microphone position, 12 “enriched” channels and one middle channel are created from the original three-channel signal with the loudspeaker positions 201, 202, 203, wherein each enriched channel comprises an omnidirectional signal and three directional differential signals so that, for the implementation of FIG. 3, the re-recorded audio piece comprises a total of 48+1, i.e. 49, channels as a third number of channels, so to speak, if the first number of channels is three and the second number of microphone systems is 12.

The following terms can be seen in FIG. 3: left, right, front, mid, rear, top, wide, side, MA triple microphone units, loudspeaker.

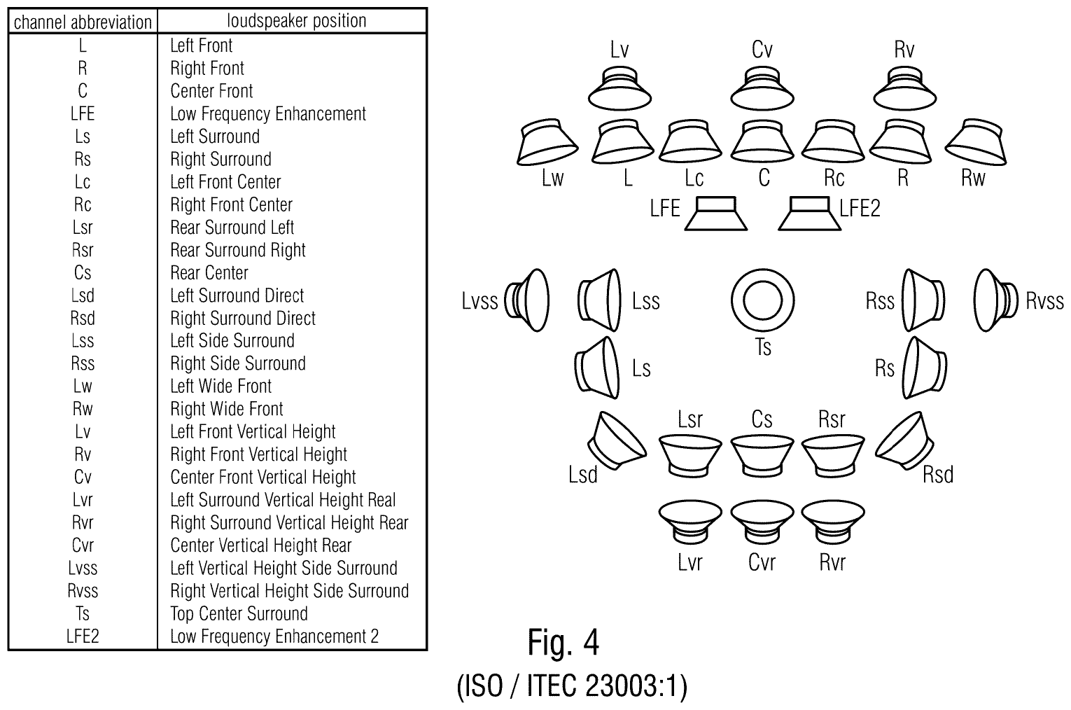

FIG. 4 shows channel abbreviations and loudspeaker positions in a top view, as illustrated from ISO/IEC 23003:1.

Here, the following terms can be seen: center, low frequency enhancement, surround, direct, side, vertical, height.

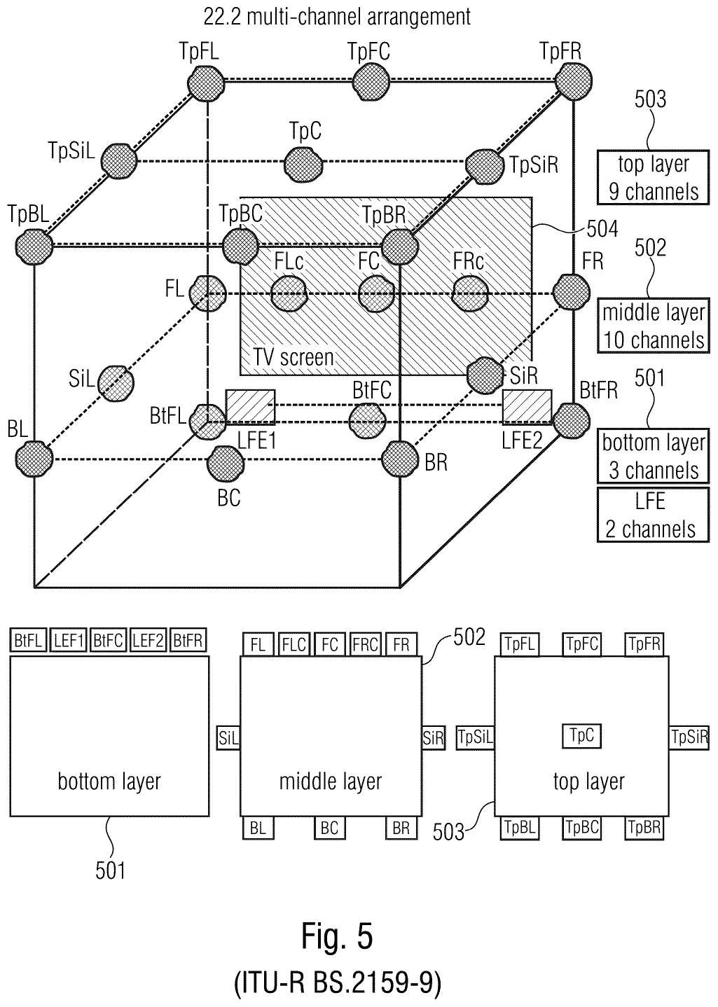

A further reproduction format, the 22.2 multichannel, as shown in FIG. 5, as is illustrated in ITU/R BS.2159-9. Here, there are three layers, i.e. the bottom layer 501, the middle layer 502, and the top layer 503. The bottom layer has three channels, the middle layer has ten channels, and the upper channel has nine channels, wherein there are additionally two subwoofers, or LFE channels. The individual abbreviations for the loudspeaker positions are illustrated in FIG. 5 in the bottom view and in the top view with respect to a TV screen 504.

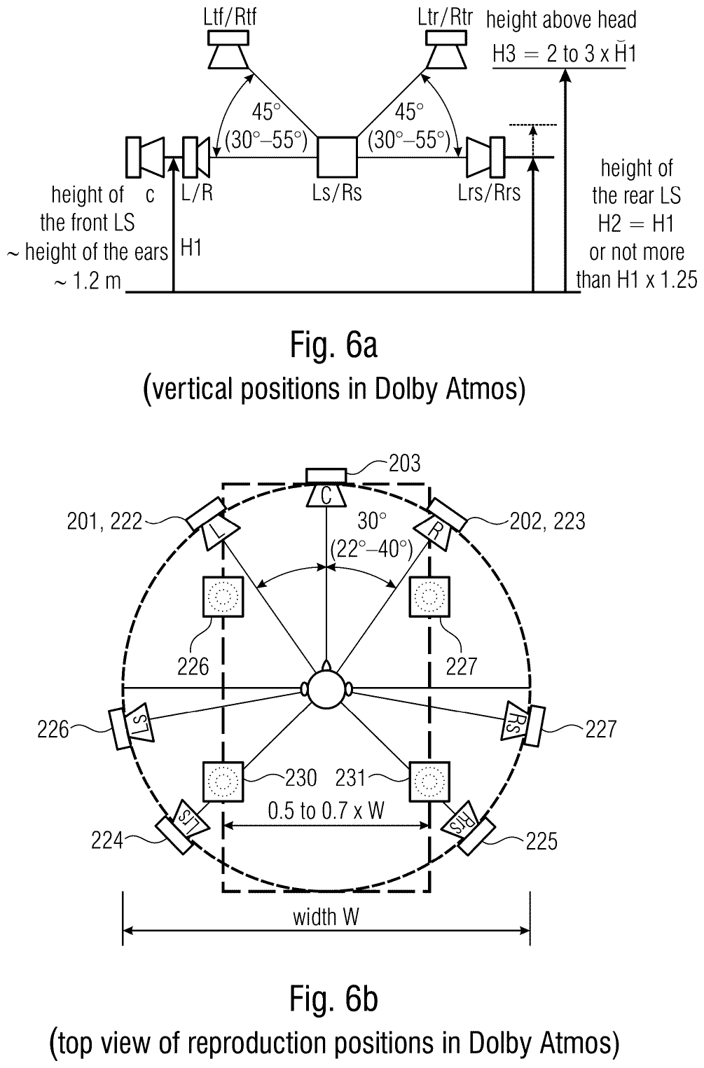

FIG. 6a and FIG. 6b show the vertical positions, or a top view of the reproduction positions in Dolby Atmos. In particular, the format shown in FIG. 6b differs from the format shown in FIG. 3 in that the two middle microphone positions, or loudspeaker positions, 228, 229 TML (top middle left) and TMR (top middle right) are still used in FIG. 3, while they are not present in FIG. 6b.

According to the invention, microphone systems may be positioned at all reproduction positions shown in FIG. 3, FIG. 4, FIG. 5, and FIGS. 6a, 6b. Also, any number of subsets of microphone systems may be placed, as can be seen from the comparison of FIG. 6b and FIG. 3, wherein the two positions TML and TMR are not occupied with microphone systems in FIG. 6b so that a smaller format is generated. Alternatively, user-specific formats that do not correspond to standardized formats may be used, however, it is advantageous to represent corresponding formats, or parts of corresponding standardized formats, with microphone systems and to then add the corresponding terms to the re-recorded audio piece in the metadata.

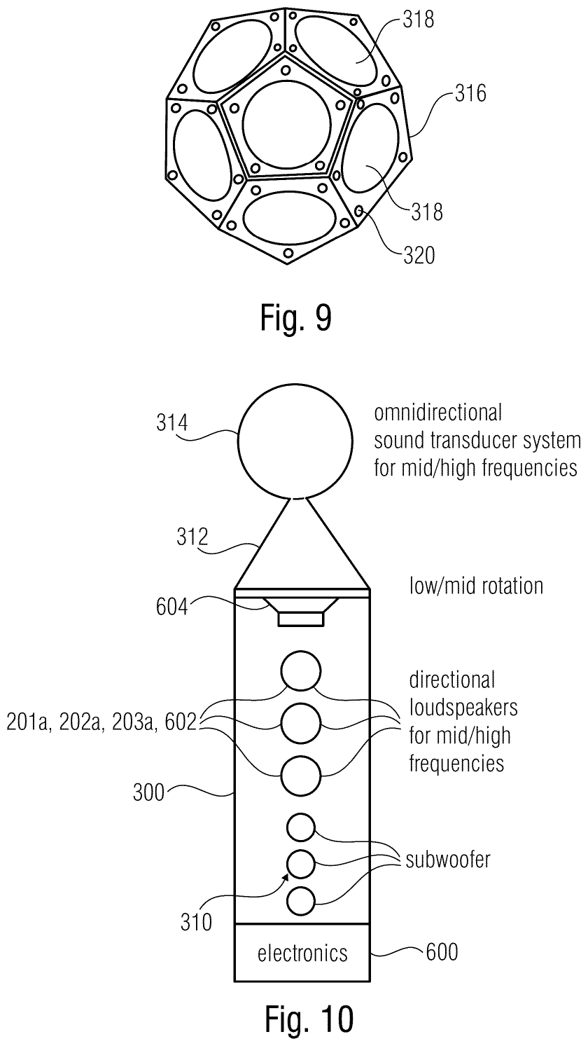

FIG. 2 shows an embodiment of the control of the three loudspeaker systems 201, 202, 203. Each individual loudspeaker system arranged at a specific loudspeaker position, e.g. the left positon, the middle position, and the right position, includes a first sound transducer system 201a, 203a, 202a for reproducing the conventional (translatory) sound signal by means of a sound transducer system referred to as a CM transducer, or Common Mode transducer. The sound transducer system may include a single loudspeaker or several loudspeakers, i.e. several loudspeaker diaphragms, typically housed and supported by a subwoofer, as will be explained with reference to FIGS. 7 to 10. In addition, each loudspeaker system includes a further sound transducer system 201b, 203b, 202b controlled with a separate audio signal and configured to generate a rotation sound field. This transducer system is referred to as DM (Differential Mode) in FIG. 2 and is symbolically indicated with two loudspeakers directed away from each other and emitting in opposing directions. However, a sound transducer system that is almost omnidirectional is used, i.e. that emits in all directions essentially equally, and is configured as a dodecahedron as is illustrated in FIG. 9.

Each audio signal is amplified by a respective amplifier 201c, 201d, 203c, 203d, 202c, 202d. Typically, the loudspeaker systems are active loudspeaker systems so that the amplifier is housed in the loudspeaker systems, as is illustrated in FIG. 2. Alternatively, the amplifiers may also be arranged separately from the loudspeakers, e.g. in the signal processing element 100, which, however, is illustrated in FIG. 2 such that it does not include the power amplifiers.

Only attenuation members 113c and 113d are used to generate the two audio signals 113a, 113b. The channel signal of the existing audio piece for the middle, i.e. track B, or the mono channel 113, is supplied to a branching point 113e, and is supplied from there, via a first attenuation member 113c, to the sound transducer system for generating the rotatory sound 203b, while the second audio signal 113 is generated such that the original signal 113 is attenuated by the second attenuation member 113d. The attenuation members 113c, 113d are adjusted differently to the extent that the attenuation member 113d attenuates less than the attenuation member 113c. By adjusting these adjustable attenuation members, it is possible to adjust the percentage of the rotatory sound for the middle channel. Even if there is just a single mono signal, the emission of the audio signal 113b, even though the signal is in-phase with respect to the audio signal 113a, leads to the fact that a rotation sound field is excited in the reproduction space due to the second sound transducer system 203b. This effect, which is also referred to as “generator effect,” leads to the fact that a rotation sound field is excited in the reproduction space even if the originally existing audio piece did not even have a stereo signal and synthetic generation of a differential mode signal is therefore not possible, which needs the presence of stereo signals. The rotation sound field generated by the transducer 203b leads to the fact that a rotation sound field is propagated, or is excited, in the reproduction space, said rotation sound field being recorded at the microphone positions with respect to a complete representation of the sound velocity, if needed, in the x, y and z directions. Thus, due to a closed reproduction space, significantly better representation may be obtained already in the inventive novel reamping of a mono signal.

The generation of the control signals 111a and 112a for the sound transducer system for reproducing the translation of sound fields takes place both, for the left channel and for the right channel by supplying the left stereo channel, or the right stereo channel, respectively, directly or after attenuation by means of an adaptable attenuation member 1105, or 1205, to the corresponding power amplifier 201d, 202d.

However, to generate the differential signal, i.e. the control signal 111b, 112b, the input-side left stereo channel 111 or 1001, and the right stereo channel 112 or 1002 are used. Thus, two polarity reversals are carried out in blocks 1015, 1016 to then add the result of the polarity reversal in the respective blocks 1013, 1014 to obtain the differential mode signals 1011 or 1012 that, depending on the embodiment, are then supplied directly or after amplification by means of a voltage-controlled amplifier (VCA) 1031, 1032 to the second sound transducer system for generating the rotation sound field. On its way to the loudspeaker, an attenuation in an attenuation member 1101 or 1201 may be carried out. In addition, depending on the implementation, a common mode signal attenuated by an attenuation member 1103 or 1203 may be added to the differential signal at the output of the amplifier 1031 or 1032, or in the output of the adder 1013, 1014, wherein the signal may be attenuated by means of an optional attenuation member 1104, 1204 at the output of the adder 1102 or 1202 carrying out the addition, so as to ultimately obtain the respective second audio signal for the DM transducer system indicated with 111b or 112b.

It is to be noted that all elements 1101, 1102, 1103, 1104, 1105, or 1201, 1202, 1203, 1204, 1205, respectively, are optional elements that, depending on the implementation, may be adjusted firmly to a specific attenuation value that differs from element to element. Alternatively, some or all elements do not have to be present, or an attenuation of 0 may be adjusted. It is also possible that only subgroups of these elements are present.

In addition, the use of the amplifier 1301 or 1302 controlled by the control signal 1035 via the branching point 1033 is optional, which is also illustrated for the optional switch that either supplies the signal 1011 or the signal 1036, or the signal 1012 or the signal 1037, respectively, to the second sound transducer system, or the DM transducer system, 201b, 202b after optional processing.

It is merely advantageous that the second audio signal, i.e. the control signals for the sound transducer system for generating the rotation sound field, is respectively derived from the differences of the two stereo channels available from the originally existing audio piece. In addition, the use of a polarity inverter 1015, 1016 and a subsequent addition at 1013, 1014 is just optional. There may also be a subtraction or an approximate subtraction to the effect that the signal at the output of the operation, i.e. the signal referred to with “A-C” or “C-A”, is based on the difference between the left stereo channel and the right stereo channel without this difference being the exact result of an exact subtraction.

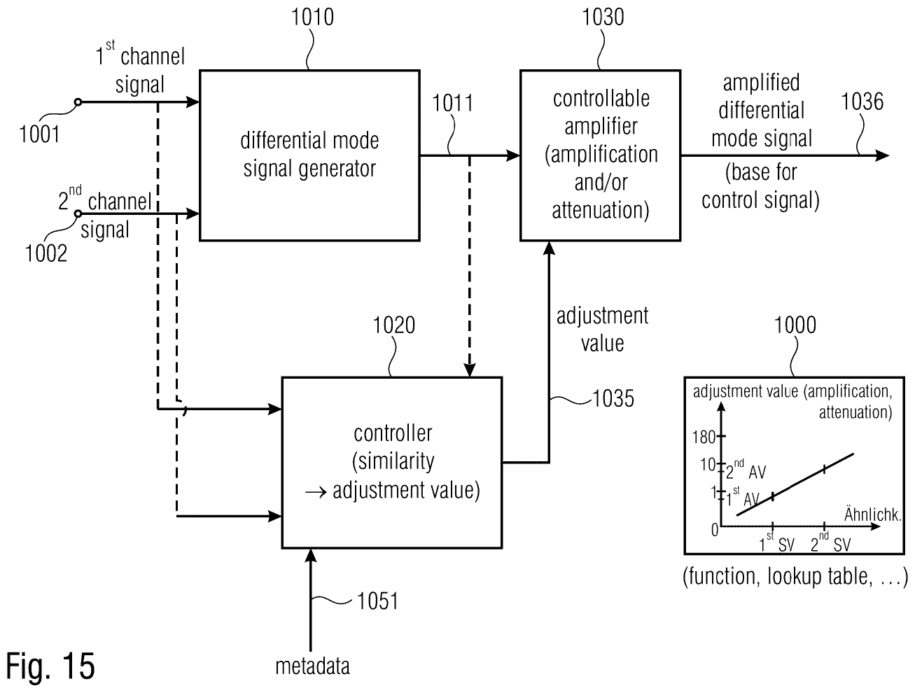

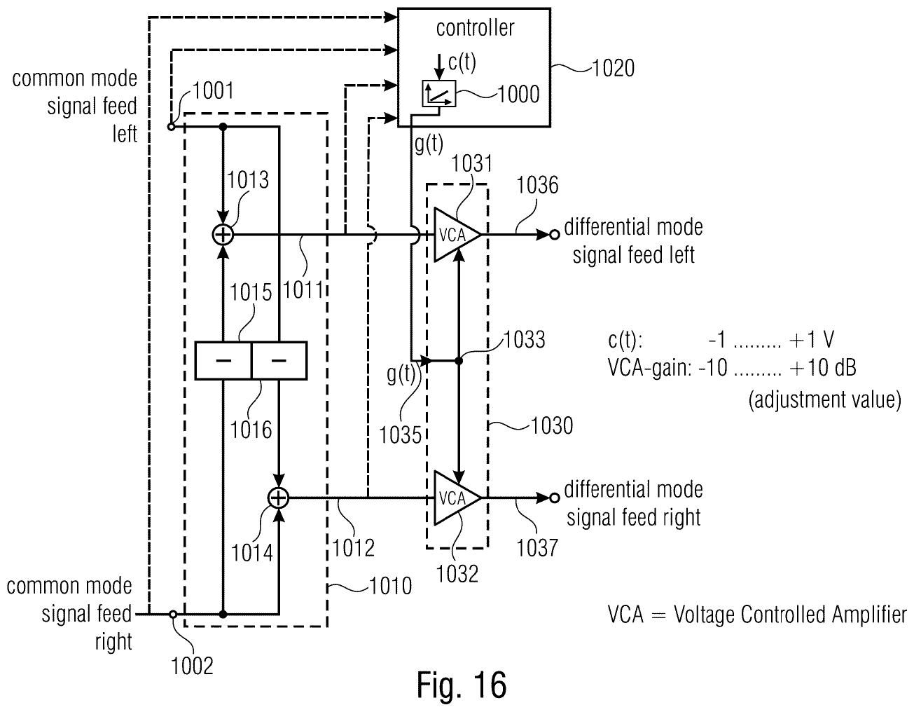

The optional use of a voltage-controlled amplifier 1031 or 1032, or the control of such an amplifier on the basis of a correlation of the left and right channel in general, is described with reference to FIGS. 15 and 16. This approach is also described in WO2022253768 A1, which is incorporated herein by reference in its entirety.

FIG. 15 shows an apparatus for generating a control signal for a sound generator, comprising a differential mode signal generator 1010, a controllable amplifier 1030, and a controller 1020. The differential mode signal generator 1010 is configured to generate a differential mode signal 1011 from a first channel signal and a second channel signal. The first channel signal 1001 and the second channel signal 1002 originate from a multi-channel audio signal and may be the left channel signal and the right channel signal, for example. The controllable amplifier 1030 is configured to amplify or to attenuate the differential mode signal 1011, namely with an adjustable amplification or attenuation according to an adjustment value 1035 which the controllable amplifier 1030 receives from the controller 1020. In particular, the apparatus in FIG. 15 is configured to use the amplified differential mode signal 1036 as a basis for the control signal for one or several sound generators.

The controller 1020 is configured to determine the adjustment value 1035 such that a first adjustment value is determined in case of a first similarity between the first channel signal and the second channel signal, and such that a second adjustment value is determined in case of a second similarity between the first channel signal and the second channel signal, wherein, in particular, the first similarity represents a lower similarity than the second similarity, and wherein the first adjustment value represents a lower amplification than the second adjustment value or a greater attenuation than the second adjustment value. This relationship is schematically illustrated in the mapping function 1000, illustrating an adjustment value for an amplification (adjustment value larger than 1) and/or for an attenuation (adjustment value smaller than 1), namely depending on a similarity scale. In particular, the amplification becomes larger and larger for greater similarity values, i.e. for stronger similarities between the first channel signal and the second channel signal. This is advantageous in that the level loss of the differential mode signal generated as a differential signal or approximate differential signal is leveled out, or partially compensated, through this. On the other hand, the more dissimilar the two channel signals are, the smaller and smaller the amplification becomes, since the level of the differential mode signal increases more and more. In particular, a special situation arises if the first channel signal and the second channel signal are particularly dissimilar, i.e. fully correlated, but inversely phased. Then, the calculation of the differential mode signal leads to an exaggeration of the level of the differential mode signal, which, according to the mapping function to map similarity values to adjustment values, as is schematically shown at 1000 in FIG. 15, is handled, according to the invention, in that the differential mode signal is amplified less or is even attenuated, i.e. with an amplification factor smaller than 1 on a linear scale or with a negative amplification factor on a logarithmic scale, such as a dB scale.

An amplification may be an amplification that leads to an increase of the level, i.e. an amplification with an amplification factor larger than 1, or a positive amplification factor on a dB scale. However, an amplification may also be an amplification with an amplification factor of less than 1, i.e. an attenuation. Then, the amplification factor is between 0.1, or in the negative range on a dB scale.

Depending on the embodiment, direct analysis of the signals to determine the adjustment value takes place in the apparatus of FIG. 15. Alternatively, the multi-channel audio signal including the first channel signal 1001, 111, and the second channel signal 1002, 112 includes metadata 1050. The controller 1020 is configured to extract the adjustment value 1035, 1051 from the metadata 1050. The controllable amplifier is configured to apply the adjustable amplification or attenuation to the differential mode signal 1011 according to the extracted adjustment value. This is illustrated by the arrow into block 1020 for the metadata at 1051. Then, direct signal analysis does not necessarily take place in the apparatus of FIG. 15. In a mixed implementation, a starting value for the adjustment value is read out from the metadata 1051, which may then be refined by an apparatus configured for actual signal analysis. On the other hand, an apparatus that cannot perform signal analysis but can only read out the metadata 1051 will use the same starting value for an entire piece, which already represents an improvement, or, at certain points in time within a piece at which a new adjustment value is available in the metadata, will use this new adjustment value to adjust the controllable amplifier(s).

The controller 1020 is configured to determine a correlation value between the first channel signal 1001 and the second channel signal 1002, wherein the correlation value is a measurement for the similarity. The controller 1020 is configured to calculate a normalized cross-correlation function from the first channel signal and the second channel signal, wherein a value of the normalized cross-correlation function is a measurement for the similarity. In particular, the controller 1020 is configured to calculate a correlation value by using a correlation function having a value range of negative and positive values, wherein the controller is configured to determine, for a negative value of the cross-correlation function, an adjustment value that represents an attenuation or amplification, and, for a positive value of the correlation function, the adjustment value that represents an amplification, or attenuation, i.e. the opposite. A typical normalized cross-correlation function has a value range of between −1 and +1, wherein the value −1 means that the two signals are fully correlated but inversely phased, and therefore dissimilar to the maximum.

On the other hand, a value of +1 is obtained if the two channel signals are fully correlated and in-phase, i.e. fully similar. The differential mode signal increases more and more with a decreasing value of −1 to 0 in case of a normalized cross-correlation function, which is why the amplification factor in this range is reduced more and more. With a value of the normalized cross-correlation function between 0 and −1, the similarity decreases more and more, which is why the differential mode signal is attenuated more and more, or is amplified less and less, to counteract the exaggeration of the differential mode signal. A similarity between the channel signals is therefore synchronous with the cross-correlation function only if the two channel signals are in phase, i.e. if the sign of the cross-correlation function is +1. However, the similarity is non-synchronous with respect to the value of the cross-correlation function if the sign of the cross-correlation function is negative.

A mapping function that may be used as a mapping function in 1000 of FIG. 1, for example, has the amplification amount aᵥ in dB on its y-axis. The similarity value along the x-axis has a value range of between −1 and +1, wherein a maximum similarity would be obtained at a value of the cross-correlation function of +1. However, a maximum dissimilarity corresponding to a value of the cross-correlation function with respect to the amount of 1 and a negative sign would lead to the fact that the amplification becomes an attenuation, i.e. an amplification of less than 1, or an amplification in the negative dB range. In such an embodiment, the relationship between the similarity value on the one hand and the adjustment value on the other hand is linear, namely up to the values of about 0.8 in an embodiment. Above values of more than 0.8, for example, the progression of the amplification to the adjustment value is drawn in a dotted line and will no longer run linearly in certain embodiments. This is due to the fact that the differential mode signal becomes smaller and smaller and, in an extreme case if signals that are 100% in phase are present at the input of the controller, could even become 0. A very strong amplification would then lead to the fact that a very small signal that would largely consist of noise will be amplified.

In this case, the amplification is either left on a maximum level, or the amplification is lowered to 0 in order to “turn off,” so to speak, the differential mode signal for such a case. Another possibility is to decrease the amplification factor in advance, as is shown by the curved dashed line that then reaches the vertical dashed line, to go into a certain compression at values of maybe 0.6 or 0.7, to go into an amplification of 0 dB at a value of 0.8 or at values of larger than 0.8 but smaller than 1.

In an alternative embodiment of the present invention, the adjustment value is not determined on the basis of the channel signals 1001, 1002, but on the basis of the differential mode signal 1011, as is illustrated by the dotted lines from the differential mode signal 1011 to the controller 1020 in FIG. 15. Here, a level, an amplitude, or another amplitude-related quantity, such as the magnitude of the amplitude, the square of the amplitude, or the third power of the amplitude, is captured as an approximation of the loudness, etc., of the differential mode signal 1011. Depending on this level, the amplification is adjusted in order to select a large amplification in case of a low level, or a low amplitude of the differential mode signal, and to use an attenuation, or an amplification with an amplification value of less than 1, in case of a high level of the differential mode signal. Depending on the implementation, the amplification-similarity mapping function may be stored in a look-up table in the controller 1020 of FIG. 1, or may be calculated by using a function with a quantitative similarity value as an input quantity and the adjustment value 1035 as an output quantity. Alternative possibilities that differ from a table or a function can also be used.

FIG. 15 shows a general implementation that can be used if only a single control signal for a single sound transducer is to be calculated. FIG. 15 further shows a base implementation in which further differential mode signals for further loudspeakers may be calculated. Such a special implementation for the calculation of two differential mode signals, i.e. a differential mode signal for a left side and a differential mode signal for the right side, for example, is illustrated in FIG. 16. In FIG. 16, in a common mode signal feed, a left channel signal is fed in as an example for the first channel signal 1001, also having the reference numeral 1011 in subsequent illustrations. Furthermore, in case of a further common mode signal feed, a right signal 1002, or 1012, may be fed in.

The differential mode signal generator 1010 is illustrated with a dashed line and includes an adder 1013, a further adder 1014, and two polarity reversal stages 1015, or 1016, respectively. This achieves calculating a first differential mode signal 1011 as a differential signal from the left channel signal and the right channel signal and generating a further differential mode signal 1012 from the difference between the right channel and the left channel, both of which are input into the controllable amplifier 1030, which includes a first individual amplifier 1031 for the left, or first, differential mode signal, and which includes a second individual amplifier 1032 for the second, or right, differential mode signal 1012. The amplifier 1030 has an input for the adjustment value g(t) that may in this case be a voltage value derived from a signed value c (t) of the normalized cross-correlation function delivering a value range of −1 und +1. The amplifiers 1031, 1032 obtain the same adjustment value via the branching point 1033 and are configured as voltage-controlled amplifiers. For the given similarity value range between −1 und +1 converted into driver voltages, i.e. into values with the dimension volt (V), they deliver an amplification of between −10 dB und +10 dB. In the embodiment shown in FIG. 16, the controller 1020 internally calculates the value c(t) of the used normalized cross-correlation function and converts this value via a mapping 1000 into the corresponding amplification value g(t) that is provided to the amplifier 1030 via the connection 1035. This value is given to a branching point 1033 and is forwarded equally to the two symbol amplifiers 1031, 1032. However, alternative different amplification values may be used for the different signals, however, wherein it is advantageous to use the same adjustment value for both differences.

Depending on the implementation, individual amplifiers 1031, 1032 may be configured to obtain a special voltage value, a special current value, or a special digital value as the adjustment value. In such a case, the controller 1020 is configured to convert a corresponding similarity value into the voltage value, current value, or digital value needed by the amplifiers 1031, 1032 by using the table 1000. In alternative embodiments, the controllable amplifier 1030 may be configured such that it already includes a conversion by means of a table 1000. Then, with respect to the terminology of the present invention, this conversion is to be considered as being part of the controller. Thus, it is to be noted that the controller 1020 and the amplifier 1030 not necessarily have to be separate physical elements, or semiconductor elements, or separate entities, but that the definitions of these elements are functional definitions. Finally, the controllable amplifier 1030 provides two differential mode signals, i.e. a first signal 1036, 72 for the left side and a second signal 1037 for the right side.

Subsequently, an embodiment of a loudspeaker system is addressed with reference to FIGS. 7 to 10. This technique is also described in WO2012130986, which is incorporated herein by reference in its entirety.

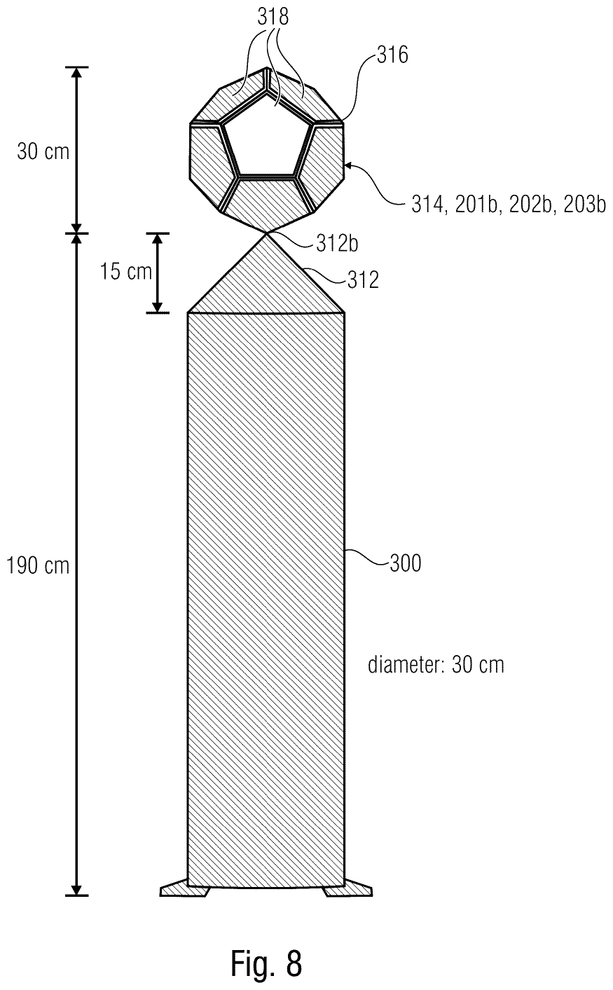

Subsequently, a loudspeaker is described with respect to FIGS. 7 and 8. The loudspeaker comprises a longitudinal enclosure 300 comprising at least one subwoofer loudspeaker 310 for emitting lower sound frequencies. Furthermore, a carrier portion 312 is provided on a top end 310a of the longitudinal enclosure. Furthermore, the longitudinal enclosures has a bottom end 310b and the longitudinal enclosure is advantageously closed throughout its shape and is particularly closed by a bottom plate 310b and the upper plate 310a, in which the carrier portion 312 is provided. Furthermore, an omnidirectionally emitting loudspeaker arrangement 314 is provided which comprises individual loudspeakers for emitting higher sound frequencies that are arranged in different directions with respect to this longitudinal enclosure 300, wherein the loudspeaker arrangement is fixed to the carrier portion 312 and is not surrounded by the longitudinal enclosure 300 as illustrated. Advantageously, the longitudinal enclosure is a cylindrical enclosure with a circle as a diameter throughout the length of the cylindrical enclosure 300. Advantageously, the longitudinal enclosure has a length greater than 50 cm or 100 cm and a lateral dimension greater than 20 cm. As illustrated in FIG. 8, an advantageous dimension of the longitudinal enclosure is 175 cm, the diameter is 30 cm, and the dimension of the carrier in the direction of the longitudinal enclosure is 15 cm, and the loudspeaker arrangement 314 is wall-shaped and has a diameter of 30 cm, which is the same as the diameter of the longitudinal enclosure. The carrier portion 312 advantageously comprises a base portion having matching dimensions with the longitudinal enclosure 300. Therefore, when the longitudinal enclosure is a round cylinder, then the base portion of the carrier is a circle matching with the diameter of the longitudinal enclosure. However, when the longitudinal enclosure is square-shaped, then the lower portion of the carrier 312 is square-shaped as well and matches in dimensions with the longitudinal enclosure 300.

Furthermore, the carrier 312 comprises a tip portion having a cross-sectional area that is less than 20% of a cross-sectional area of the base portion, where the loudspeaker arrangement 314 is fixed to the tip portion. Advantageously, as illustrated in FIG. 8, the carrier 312 is cone-shaped so that the entire loudspeaker illustrated in FIG. 8 looks like a pencil having a ball on top. This is advantageous due to the fact that the connection between the omnidirectional loudspeaker arrangement 314 and the subwoofer-provided enclosure is as small as possible, since only the tip portion 312b of the carrier is in contact with the loudspeaker arrangement 314. Hence, there is a good sound decoupling between the loudspeaker arrangement and the longitudinal enclosure. Furthermore, it is advantageous to place the longitudinal enclosure below the loudspeaker arrangement, since the omnidirectional emission is even better when it takes place from above rather than from below the longitudinal enclosure.

The loudspeaker arrangement 314 has a sphere-like carrier structure 316, which is also illustrated in FIG. 9 as a further example. The individual loudspeakers are mounted so that each individual loudspeaker emits in a different direction. In order to illustrate the carrier structure 316, FIG. 8 illustrates several planes, where each plane is directed into a different direction and each plane represents a single loudspeaker with a diaphragm such as a straightforward piston-like loudspeaker, but without any back casing for this loudspeaker. The carrier structure can be implemented specifically as illustrated in FIG. 9 where, again, the loudspeaker rooms or planes 318 are illustrated. Furthermore, it is advantageous that the structure as illustrated in FIG. 9 additionally comprises many holes 320 so that the carrier structure 360 only fulfills its functionality as a carrier structure, but does not influence the sound emission and particularly does not hinder that the diaphragms of the individual loudspeakers in the loudspeaker arrangement 314 are freely suspended. Due to the fact that freely suspended diaphragms generate a good rotation component, a useful and high quality rendering of rotation sound can be produced. Therefore, the carrier structure is as little bulky as possible so that it only fulfills its functionality of structurally supporting the individual piston-like loudspeakers without influencing the possibility of deflections of the individual diaphragms.

Advantageously, the loudspeaker arrangement comprises at least six individual loudspeakers and particularly even twelve individual loudspeakers arranged in twelve different directions, where, in this example, the loudspeaker arrangement 314 comprises a pentagonal dodecahedron (e.g. body with 12 equally distributed surfaces) having twelve individual areas, wherein each individual area is provided with an individual loudspeaker diaphragm. Importantly, the loudspeaker arrangement 314 does not comprise a loudspeaker enclosure and the individual loudspeakers are held by the supporting structure 316 so that the diaphragms of the individual loudspeakers are freely suspended.

Furthermore, as illustrated in FIG. 10 in a further example, the longitudinal enclosure 300 not only comprises the subwoofer, but also additionally comprises electronic parts necessitated for feeding the subwoofer loudspeaker and the loudspeakers of the loudspeaker arrangement 314. Additionally, the longitudinal enclosure 300 not only comprises a single subwoofer. Instead, one or more subwoofer loudspeakers can be provided in the front of the enclosure, where the enclosure has openings indicated at 310 in FIG. 10, which can be covered by any kind of covering materials such as a foam-like foil or so. The whole volume of the closed enclosure serves as a resonance body for the subwoofer loudspeakers. The enclosure additionally comprises one or more directional loudspeakers for medium and/or high frequencies indicated at 602 in FIG. 10, which are advantageously aligned with the one or more subwoofers indicated at 310 in FIG. 10. These directional loudspeakers are arranged in the longitudinal enclosure 300 and if there is more than one such loudspeaker, then these loudspeakers are advantageously arranged in a line as illustrated in FIG. 10, and the entire loudspeaker is arranged with respect to the listener so that the loudspeakers 602 are facing the listeners. Then, the individual loudspeakers in the loudspeaker arrangement 314 are provided with the second capturing signal or the second audio signal, and the directional loudspeakers are provided with the corresponding first capturing signal or first audio signal. Hence, each individual loudspeaker has an omnidirectional arrangement 316, a directional arrangement 602 and a subwoofer 310. Advantageously, the three loudspeakers 602 are arranged in a d′Appolito arrangement, i.e. the upper and the lower loudspeakers are mid frequency loudspeakers and the loudspeaker in the middle is a high frequency loudspeaker.

Alternatively, however, the loudspeaker in FIG. 10 can be used without the directional loudspeaker 602 in order to implement the omnidirectional arrangement in FIG. 1b for each loudspeaker place, and an additional directional loudspeaker can be placed, for example, close to the middle position only or close to each loudspeaker position in order to reproduce the sound with high directivity separately from the sound with low directivity.

The enclosure furthermore comprises a further loudspeaker 604 which is suspended at an upper portion of the enclosure and which has a freely suspended diaphragm. This loudspeaker is a low/mid loudspeaker for a low/mid frequency range between 80 and 300 Hz and advantageously between 100 and 300 Hz. This additional loudspeaker is advantageous, since—due to the freely suspended diaphragm—the loudspeaker generates rotation stimulation/energy in the low/mid frequency range. This rotation enhances the rotation generated by the loudspeakers 314 at low/mid frequencies. This loudspeaker 604 receives the low/mid frequency portion of the signal provided to the loudspeakers at 314, e.g. the second capturing signal or the second mixed signal.

In an embodiment with a single subwoofer, the subwoofer is a twelve inch subwoofer in the closed longitudinal enclosure 300, and the loudspeaker arrangement 314 is a pentagon dodecahedron mid/high loudspeaker arrangement with freely vibratable mid frequency diaphragms.

Subsequently, an embodiment of a microphone arrangement is described with reference to FIGS. 11 to 14, which, if only a single differential signal is to be captured, may be configured with a single partial microphone, however, is configured with two or even three partial microphones so as to capture the entire sound velocity in the x, y, and z directions. This technique is also described in WO2022157252A1, which is incorporated herein by reference in its entirety.

FIG. 11 shows a first partial microphone 1 with a diaphragm pair comprising a first diaphragm 11 and a second diaphragm 12 that are arranged opposite each other. Above that, FIG. 11 shows a second partial microphone 2 with a second diaphragm pair comprising a third diaphragm 13 and a fourth diaphragm that are arranged opposite each other. The first diaphragm pair is arranged such that the first diaphragm 11 and the second diaphragm are deflectable along a first spatial axis, such as the x-axis wherein further the second diaphragm pair is arranged such that the third diaphragm 13 and the fourth diaphragm 14 are deflectable along a second spatial axis, such as the y-axis of FIG. 11. The spatial axis differs from the first spatial axis, i.e., the two spatial axis are not parallel. The two spatial axis x, y are orthogonal to one another or have an angle that is between 6° and 120°.

Further, FIG. 12 shows a third partial microphone 13 with a third diaphragm pair comprising a fifth diaphragm 15 and a sixth diaphragm 16 that are arranged opposite each other, wherein the third diaphragm pair is arranged such that the fifth diaphragm 15 and the sixth diaphragm 16 are deflectable along a third spatial axis, such as the z-axis. The third spatial axis differs from the first spatial axis and the second spatial axis, wherein all three spatial axis are orthogonal to one another. Different angles between the third spatial axis and the first or second spatial axis, such as in a range between 6° and 120° are advantageous.

Further, FIG. 12 shows for each diaphragm 11 to 16 a very schematic sensitivity characteristic that traditionally either has the letter F or the letter R. F stands for front and R stands for rear. The difference in sensitivity characteristics of the individual diaphragms each of which typically having a counterelectrode are also arranged opposite each another.

As shown further for example in FIG. 11 or FIG. 12 it is advantageous that the diaphragms of the different diaphragm pairs are directly opposite, parallel to one another and aligned to one another, wherein further a distance between the two diaphragm pairs is small and less than 2 cm. Further, it is advantageous that the distance for each diaphragm pair is essentially the same within a tolerance. Further, FIG. 11 shows output lines for each diaphragm. In particular, the first partial microphone 1 is configured such that in response to a deflection of the first diaphragm 11, a first diaphragm signal is provided and that in response to a deflection of the second diaphragm, a second diaphragm signal is provided, which has a specific phase relation to the first diaphragm signal that results due to the arrangement of the diaphragms or the wiring or the indicated sound or the recorded sound field.

Above that, the second partial microphone 2, which includes the two diaphragms 13, 14, also comprises output lines to provide a third diaphragm signal from the third diaphragm 13 and a fourth diaphragm signal from the fourth diaphragm 14. Further, depending on the implementation, the third partial microphone is also configured to provide a fifth diaphragm signal in response to a deflection of the fifth diaphragm 15 and to provide a sixth diaphragm signal in response to a deflection of the diaphragm 16 in the third spatial axis, i.e., for example in the z direction.

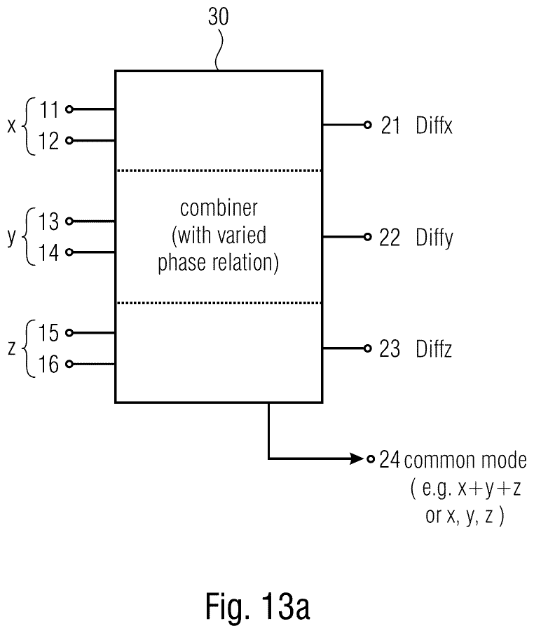

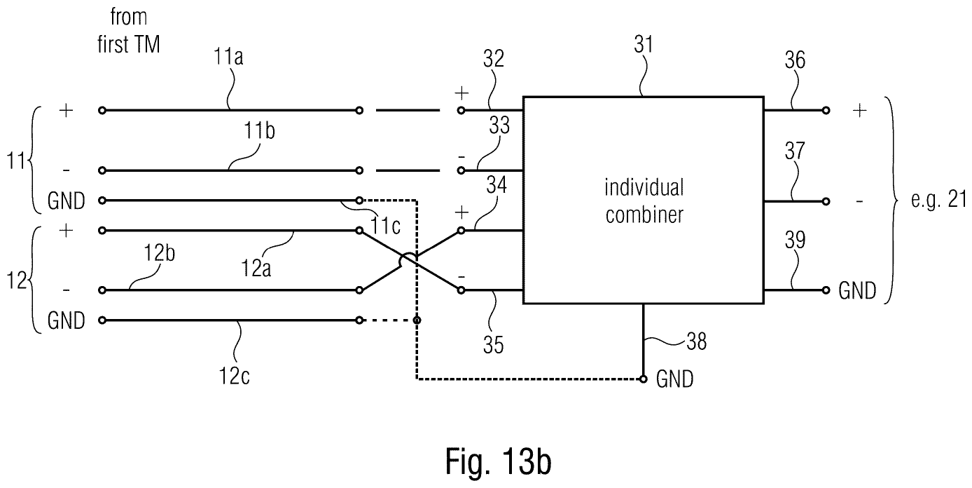

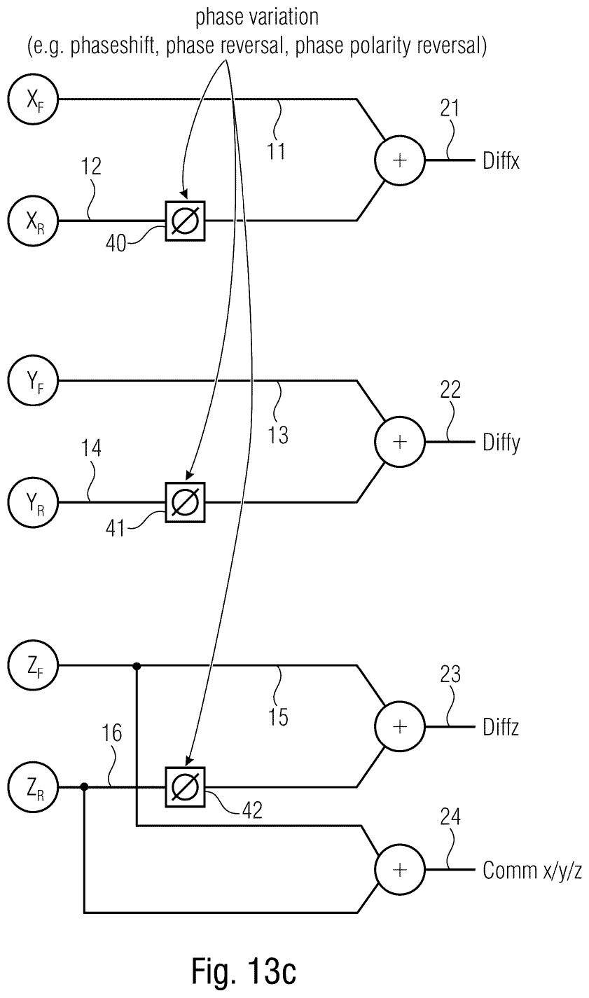

The first partial microphone, the second partial microphone and, if present, the third partial microphone are configured to combine the respective diaphragm signals of the diaphragms of the diaphragm pair. This is illustrated schematically in FIG. 13a by a schematic combiner that is shown at 30 as one block for all two or three partial microphones. However, a respective individual combiner as shown, for example, in FIG. 13b at 31 can exist for each individual partial microphone, such that the diaphragm signals of one partial microphone are combined, however, such that diaphragm signals of different partial microphones are not combined at least for generating a first differential output signal 21 for the first partial microphone, a second differential output signal 22 for the second partial microphone and a third differential output signal 23 for the third partial microphone. However, in embodiments, the combiner 30 is configured to form not only the differential signals 21, 22, 23 but also common mode or CM signals 24. These CM signals 24 can be, for example, merely individual component signals X, Y, Z as known from ambisonics technology, or an omnidirectional signal that is obtained, for example, when the diaphragm signals of all individual diaphragms are added up without phase shift of individual diaphragm signals.

For generating a differential signal as, for example, the differential output signal Diffx 21, the combiner 30 is configured to combine the first diaphragm signal 11 and the second diaphragm signal 12 with a modified first phase relation. Thus, the first differential output signal Diffx 21 is allocated to the first spatial axis, for example the x-axis.

Further, the second partial microphone is configured to combine the second diaphragm signal 13 and the third diaphragm signal 14 with a modified second phase relation to provide a second differential output signal Diffy shown at 22 in FIG. 13a and allocated to the second spatial axis y. Further, the third partial microphone is configured to combine the fifth diaphragm signal 15 and the sixth diaphragm signal 16 with a phase relation modified with respect to the third phase relation to provide a third differential output signal that is shown at 23 in FIG. 13a and allocated to the spatial axis z.

The combination is performed such as it is schematically illustrated in FIG. 13c. For modifying the first phase relation between the first diaphragm signal 11 and the second diaphragm signal 12 FIG. 13c shows schematically a phase changing member 40 having a phase value of 180°, wherein the phase angle of the phase member can be in the range between 90° and 270°. However, in the most advantageous embodiment, the range is 170° to 190° or 180°.

The phase changing means 41 is provided to change the second phase relation for the second partial microphone such that an addition as schematically show in FIG. 13c takes place with modified second phase relation.

Above that, also for the third partial microphone, a phase changing element 42 is provided that changes the third phase relation between the diaphragm signals 15, 16 and adds the signals with modified third phase relation to obtain the third differential output signal Diffz 23 of FIG. 13c.

As illustrated already based on reference number 24 in FIG. 13a, the combiner is also configured to form conventional common mode signals. To form a CM-z signal, the fifth diaphragm signal 15 and the sixth diaphragm signal 16 are added with the original third phase relation, i.e., for example without the effect of a phase member 42.

The same is performed to obtain a conventional y-directional component of a directional microphone by adding the diaphragm signals of the second diaphragm pair 13, 14 with the original phase relation, i.e., without the effect of a phase member 41. Analogously, an X component of a directional microphone is obtained when the two directional characteristics, i.e., for the front diaphragm 11 and the rear diaphragm 12 are added, again without effect of a phase element 40.

An entire omnidirectional signal can be obtained when all six diaphragm signals are added in their original first second and third phase relation, wherein this omnidirectional signal, for example, is referred to as W signal or P signal as it is also known from ambisonics technology or for a signal in B-format which comprises an omnidirectional component and directional component in X-direction, a directional component in Y-direction and a Z-component in the Z-direction.

In contrary to such a B-format signal, the inventive microphone provides, in addition to these signals or as an alternative to these signals, differential signals for the individual directions, i.e., signals that result when a difference between the front and the rear directional characteristic is formed to detect the sound field which actually prevails on the side with respect to diaphragms that are arranged opposite each other, i.e., above and below the two diaphragms 11, 12 of FIG. 11.

The change between the first phase relation on the left in FIG. 13c and the second phase relation on the right in FIG. 13c from the respective addition can be obtained by an actually provided phase shifter, a delay line, a phase inversion, or also a phase pole reversal. The latter case of phase pole reversal is used for an embodiment where the diaphragm signals are transmitted as symmetrical signals between a plus line 11a and minus line 11b. Such a schematic illustration of the diaphragm signal 11 is shown in FIG. 13b, wherein the “line” 11 in FIG. 13c corresponds to the positive individual line 11a, the negative individual line 11b, and ground (GND) 11c. The same applies for the second diaphragm signal 12, which consists again of a positive line 12a, negative line 12b, and a common ground 12c. The actual diaphragm signal is transmitted as difference between the positive and negative line as it is known for symmetrical line transmission.

For combining such a signal, the combiner 30 is configured as illustrated in FIG. 13b for an individual combiner 31. The individual combiner 31 would be provided for each of the three partial microphones 1, 2, 3 of FIG. 11 in its respective implementation. The individual combiner 31 has two inputs 32, 34 for the positive potential and two inputs 33, 35 for the negative potential as well as one (or two) ground inputs 38 for the ground potential GND. In order to obtain the phase inversion as illustrated in FIG. 13c by the element 40 or 41 or 42, in the embodiment shown in FIG. 13b with symmetrical signal transmission, the polarity of the positive and negative line is reversed, as shown on the left in FIG. 13b for the diaphragm signal 12. The positive line 12b is connected to negative input 35 and the negative line 12b is connected to the positive input 34. At the output, the individual combiner provides the differential signal 21 indicated by Diffx, which is again transmitted as a differential signal between the positive line 36 and the negative line 37, wherein an output ground 39 (GND) is also provided.

Although such an individual combiner is illustrated in FIG. 13b merely for the first partial microphone it is advantageous to use such an individual combiner also for the second partial microphone and for the third partial microphone.

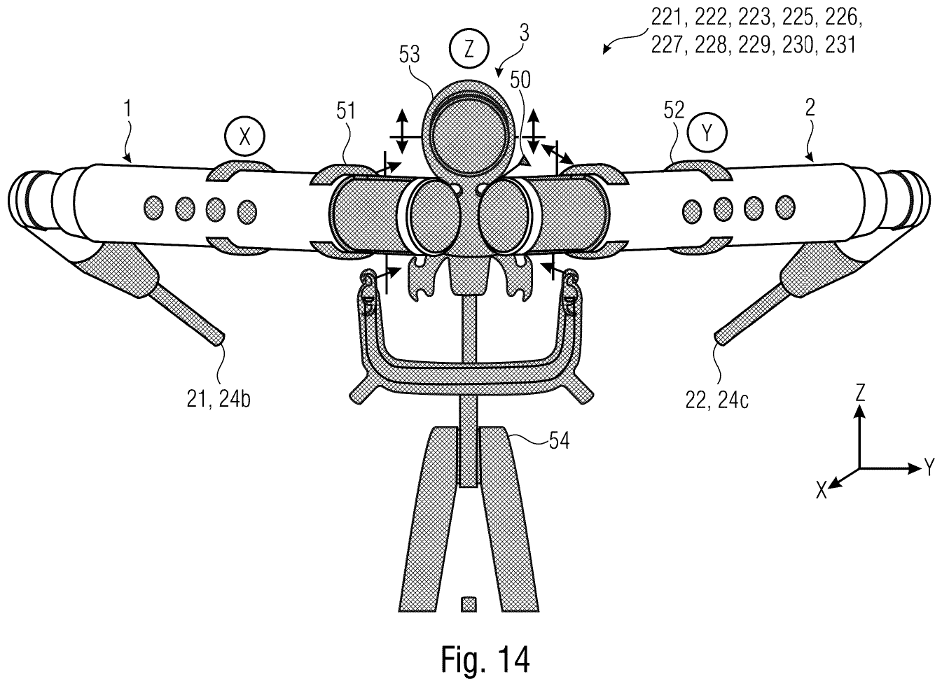

FIG. 14 shows an embodiment of the microphone wherein the three partial microphones are all held by a diaphragm holder 50, wherein each partial microphone comprises a longitudinal housing, wherein the diaphragm pairs are arranged in the respective tip of the partial microphone, protected from the outside by a permeable grid. In particular, the two diaphragms of the first partial microphone 1 are arranged in the y-z plane, such that a deflection in the x-direction is obtained. Above that, the two diaphragms of the second partial microphone 2 are arranged in the x-z plane to obtain deflection in the y-direction, i.e. in the second spatial axis. Above that, the two diaphragms of the third partial microphone 3 are arranged in the x-y plane to be deflected by sound in the Z-direction. Further, the individual partial microphones have an output line that either routes the individual diaphragm signals to the outside or that already route the differential output signal 21, 22 or 23 (not shown in FIG. 14) to the outside. Depending on what electronics is already incorporated in the longitudinal housing of the respective partial microphone, the individual lines can also route the conventional common mode components in the individual direction to the outside, as shown at 24b, 24c for x and y, wherein the signal Z, which will be discussed based on FIG. 7, is not illustrated in FIG. 14 but can already be generated by the third partial microphone 3, within the longitudinal housing.

The three partial microphones are configured such that each diaphragm comprises a counterelectrode, such that six individual diaphragms and six respective counterelectrodes exist overall in the inventive microphone shown in FIG. 14. These counterelectrodes form an individual capacitor microphone for each diaphragm, wherein, depending on the implementation, a capacitor or electret foil can be deposited on the respective counterelectrode to have six individual capacitor or electret microphones in the arrangement shown in FIG. 14. The “tips” of the three partial microphones 1, 2, 3 are directed to a common area or a common axis to position the three diaphragm pairs as close as possible to one another to be able to detect a rotational vibration illustrated by their three individual components, which indicate the direction of rotation. To obtain this, a microphone holder provided, which is shown at 50 in FIG. 14. The microphone holder has a triangular shape but can also have a kite shape or can also have a different shape. The same includes two sides having an angle of 90° to one other to align the partial microphone 1 and the partial microphone 2 at an angle of 90° to one another. For this, a first holder 51 is provided, which is provided on the first side of the two rectangular sides, and a second holder 52, which is provided at the other side of the two rectangular sides. A third holder 53 is provided to hold the third microphone, which is configured in the bisecting line of the 90° angle of the two sides where the first holder 51 and the second holder 52 are provided and projects from the drawing plane to bring the third partial microphone as close as possible, with respect to its sensitive microphone tip to the two microphone tips of the first and second partial microphone. The holders 51, 52 and 53 are configured as clips to be able to mount the individual partial microphones without any tools. Other holding means can also be provided to hold the longitudinal partial microphones in the respective angular form, such that the diaphragm pairs are aligned as illustrated based on FIG. 11 or FIG. 12. For other arrangements where the exact rectangular arrangement between the individual microphones is not important, the microphones can also be arranged at an angle between 70° and 110° or the third holder 53 or the third partial microphone can be arranged at an angle between 30° and 60° with respect to the first holder or the second holder. The microphone holder 50 is further mounted to a tripod 54 shown schematically in FIG. 14. Instead of the tripod 54, the microphone can also be suspended from a ceiling with a rope structure in order to have the bottom area free, for example, when a stage is to be recorded. Instead of the elastic clips illustrated in FIG. 14 for the individual holders, magnetic holders, latching elements or other holders can be used.

An inventive re-recorded audio piece includes at least for the first channel a first pressure signal, a first directional differential signal, and a second directional differential signal; and for a second channel a second pressure signal, a third directional differential signal and fourth directional differential signal. As described and illustrated in FIG. 1c, the audio piece may include a large number of further channels, or pressure signals and/or directional differential signals. Furthermore, it may be recorded on a physical, e.g., a non-volatile or digital, storage medium.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. Apparatus for re-recording an existing audio piece with a first number of channels, comprising:
a loudspeaker arrangement for reproducing the first number of channels with a first number of loudspeaker systems in a reproduction space, wherein the first number is 1 or larger than 1, and wherein the one loudspeaker system or the loudspeaker systems of the first number of loudspeaker systems is/are configured to generate, for each channel of the first number of channels, a translation sound field and a rotation sound field in the reproduction space;
a microphone arrangement with a second number of microphone systems arranged at different microphone positions in the reproduction space, wherein each microphone system of the second number of microphone systems is configured to capture a pressure signal and additionally a directional differential signal; and
an interface for outputting or recording the pressure signal and the directional differential signal or a differential signal derived from the directional differential signal as a re-recorded audio piece.

2. Apparatus according to claim 1, wherein the existing audio piece comprises a mono-channel and the first number is 1,
wherein a single loudspeaker system is arranged in a middle loudspeaker position with respect to a listener position in the reproduction space, wherein the second number is larger than the first number, and
wherein the microphone arrangement comprises at least one first microphone system at a first left microphone position with respect to the listener position in the reproduction space and a second microphone system at a second right microphone position with respect to the listener position in the reproduction space.

3. Apparatus according to claim 1, wherein the existing audio piece comprises a first left channel and a second right channel and the first number is 2 or 3,
wherein a first loudspeaker system of the first number of loudspeaker systems is arranged at a left loudspeaker position with respect to a listener position in the reproduction space,
wherein a second loudspeaker system of the second number of loudspeaker systems is arranged at a right loudspeaker position with respect to the listener position in the reproduction space, and
wherein the microphone arrangement comprises at least one first microphone system at a first left microphone position with respect to the listener position in the reproduction space and one second microphone system at a second right microphone position with respect to the listener position in the reproduction space.

4. Apparatus according to claim 3, wherein the existing audio piece further comprises a middle channel and the first number is 3, wherein a further loudspeaker system is arranged at a middle loudspeaker position with respect to the listener position in the reproduction space so as to generate a translational sound field and a rotatory sound field for the middle channel.

5. Apparatus according to claim 4, wherein the interface is configured to copy into the re-recorded audio piece the middle channel as the middle channel of the re-recorded audio piece.

6. Apparatus according to claim 1, wherein the second number is larger than the first number, and
wherein a third number of channels in the re-recorded audio piece is at least twice as large as the second number, wherein the respective pressure signal represents a channel of its own in the third number and the respective directional differential signal or the differential signal derived from the directional differential signal also represents a channel of its own in the third number of channels.

7. Apparatus according to claim 1, wherein each channel of the first number of channels has associated therewith a different reproduction position of its own in a first reproduction format, and wherein the one or the several loudspeaker systems of the first number of loudspeaker systems is/are arranged at the reproduction position(s) of the first reproduction format in the reproduction space, and
wherein each microphone system is arranged at a reproduction position of its own of a second reproduction format, wherein the second reproduction format differs from the first reproduction format.

8. Apparatus according to claim 7, wherein the first reproduction format is a mono format, a stereo format, or a 3-channel format with a left channel, a middle channel and a right channel, or
wherein the second reproduction format is an ITU-recommended reproduction format comprising at least one layer from a group of layers, comprising a bottom layer, a middle layer and a top layer, wherein at least one loudspeaker position of a first loudspeaker system belongs to the top layer and at least one loudspeaker position of a second loudspeaker system belongs to the middle layer, or is a Dolby Atmos reproduction format, or a MPEG reproduction format, or comprises part of any of the above-mentioned reproduction formats.

9. Apparatus according to claim 1, wherein the existing audio piece has been recorded in an original reproduction space with specific original room acoustics, and
wherein the reproduction space is the same reproduction space as the original reproduction space, or is another reproduction space whose room acoustics are equal to or similar to the original room acoustics.

10. Apparatus according to claim 1, wherein each loudspeaker system of the first number of loudspeaker systems comprises:
a first sound transducer system;
a second sound transducer system;
a first input for a first audio signal deliverable to the first sound transducer system so as to generate the translation sound field; and
a second input for a second audio signal different from the first audio signal and deliverable to the second sound transducer system so as to generate the rotation sound field,
wherein the second sound transducer system is configured to emit sound omnidirectionally or with lower directionality or quality factor than the first sound transducer system.

11. Apparatus according to claim 10, wherein the first sound transducer system comprises one or several loudspeakers orientated in a direction and housed in an enclosure, or
wherein the second sound transducer system comprises a plurality of individual loudspeakers each of which being orientated in different direction, wherein a direction in which a loudspeaker of the plurality of individual loudspeakers is orientated differs from the direction in which the loudspeakers of the first sound transducer system are orientated.

12. Apparatus according to claim 10, wherein the second sound transducer system comprises a circular carrier structure having arranged thereon the individual loudspeakers unhoused loudspeakers with loudspeaker diaphragms so that, during operation, the loudspeaker diaphragms emit in different directions.

13. Apparatus according to claim 10, wherein the second sound transducer system comprises at least six individual loudspeakers, or comprises a dodecahedron with 12 individual areas, wherein an individual loudspeaker of the plurality of loudspeakers of the second sound transducer system is arranged on an area of the 12 individual areas of the dodecahedron each.

14. Apparatus according to claim 10, further comprising a signal processing element so as to generate, from each channel of the first number of channels of the existing audio piece, the first audio signal and the second audio signal for the loudspeaker system associated with the channel.

15. Apparatus according to claim 14, wherein the first number of channels comprises a middle channel, wherein the signal processing element is configured to derive, from the middle channel, both the first audio signal and the second audio signal for the loudspeaker system associated with the middle channel, from the middle channel by means of attenuation or amplification.

16. Apparatus according to claim 15, wherein the signal processing element is configured to derive the first audio signal and the second audio signal such that the second audio signal has less power than the first audio signal.

17. Apparatus according to claim 14, wherein the first number of channels comprises a left channel and a right channel, and wherein the signal processing element is configured to generate the first audio signal for the loudspeaker system associated with the left channel from the left channel without the right channel or with the right channel, wherein a power percentage of the right channel in the first audio signal is smaller than 1/10 of the power percentage of the left channel in the first audio signal, and
wherein the signal processing element is configured to generate the second audio signal for the loudspeaker system associated with the right channel from the right channel without the left channel or with the left channel, wherein a power percentage of the left channel in the first audio signal is smaller and 1/10 of the power percentage of the right channel in the first audio signal.

18. Apparatus according to claim 14, wherein the first number of channels comprises a left channel and a right channel, and
wherein the signal processing element is configured to determine, from a difference of the left channel and the right channel or from an addition of the left and the right channel, the second audio signal for the loudspeaker system associated with the left channel, or the second audio signal for the loudspeaker system associated with the right channel, wherein a channel of the left or the right channel has been reversed in its polarity prior to the addition.

19. Apparatus according to claim 18, wherein the signal processing element is configured to use a result of the difference formation or the addition regardless of a correlation between the left channel and the right channel for the generation of the respective second audio signal, or to amplify or attenuate the results of the difference formation or the addition in a signal-dependent manner, e.g. depending on a correlation between the first channel and the second channel, and to use the result of the amplification or the attenuation for the generation of the respective second audio signal.

20. Apparatus according to claim 19, wherein the signal processing element is configured to attenuate the left or the right channel and, in the generation of the respective second audio signal, to add a result of the attenuation to the result of the difference formation or the addition or to the result of the amplification or attenuation.

21. Apparatus according to claim 10, wherein the loudspeaker system for the first audio signal and the second audio signal each comprises a power amplifier.

22. Apparatus according to claim 10, wherein one or several of the microphone systems of the microphone arrangement comprise:
a first partial microphone with a first diaphragm pair comprising a first diaphragm and a second diaphragm arranged opposite each another; and
a second partial microphone with a second diaphragm pair comprising a third diaphragm and a fourth diaphragm arranged opposite each another,
wherein the first diaphragm pair is arranged such that the first diaphragm and the second diaphragm are deflectable along a first spatial axis, and
wherein the second diaphragm pair is arranged such that the third diaphragm and the fourth are deflectable along a second spatial axis,
wherein the second spatial axis differs from the first spatial axis.

23. Apparatus according to claim 22, comprising:
a third partial microphone with a third diaphragm pair comprising a fifth diaphragm and a sixth diaphragm arranged opposite each another, wherein the third diaphragm pair is arranged such that the fifth diaphragm and the sixth diaphragm are deflectable along a third spatial axis,
wherein the third spatial axis differs from the first spatial axis and the second spatial axis.

24. Apparatus according to claim 22, wherein the spatial axes are orthogonal to one another or wherein there is an angle of between 60° and 120° between the two spatial axes.

25. Apparatus according to claim 22,
wherein the diaphragms of the first diaphragm pair, the second diaphragm pair, and the third diaphragm pair, respectively, are arranged in parallel directly opposite each another, or are arranged in a distance of less than 2 cm to each other.

26. Apparatus according to claim 22,
wherein the first partial microphone is configured to provide a first diaphragm signal responsive to a deflection of the first diaphragm, and to provide a second diaphragm signal responsive to a deflection of the second diaphragm, wherein the first diaphragm signal and the second diaphragm signal comprise a first phase relation, wherein the first partial microphone is configured to combine the first diaphragm signal and the second diaphragm signal with a modified first phase relation so as to provide a first difference output signal associated with the first spatial axis, or
wherein the second partial microphone is configured to provide a third diaphragm signal responsive to a deflection of the third diaphragm, and to provide a fourth diaphragm signal responsive to a deflection of the fourth diaphragm, wherein the third diaphragm signal and the fourth diaphragm signal have a second phase relation, wherein the second partial microphone is configured to combine the third diaphragm signal and the fourth diaphragm signal with a modified second phase relation so as to provide a second difference output signal associated with the second spatial axis, or
wherein a third partial microphone is configured to provide a fifth diaphragm signal responsive to a deflection of a fifth diaphragm, and to provide a sixth diaphragm signal responsive to a deflection of a sixth diaphragm, wherein the fifth diaphragm signal and the sixth diaphragm signal comprise a third phase relation, and wherein the third partial microphone is configured to combine the fifth diaphragm signal and the sixth diaphragm signal with a modified third phase relation so as to provide a third difference output signal associated to the third spatial axis.

27. Apparatus according to claim 26,
wherein the modified first phase relation differs by 180° from the first phase relation or differs by a phase of between 150° and 210° from the first phase relation, or
wherein the modified second or third phase relations differ by 180° from the second or third phase relations or differ by a phase of between 150° and 210° from the second or third phase relations, respectively.

28. Apparatus according to claim 25,
wherein the first diaphragm signal is transferred as a symmetrical signal on a first positive line and a first negative line,
wherein the second diaphragm signal is transferred as a symmetrical signal on a second positive line and a second negative line,
wherein the first partial microphone comprises a combiner with a first positive input and first negative input for the first diaphragm signal and with a second positive input and second negative input for the second diaphragm signal,
wherein the second negative line of the second diaphragm signal is connected to the second positive input of the combiner, and wherein the second positive line of the second diaphragm signal is connected to the second negative input of the combiner, and
wherein the first positive line of the first diaphragm signal is connected to the first positive input of the combiner, and wherein the first negative line of the first diaphragm signal is connected to the first negative input of the combiner.

29. Apparatus according to claim 25, wherein the first partial microphone is configured to add the first diaphragm signal and the second diaphragm signal in the first phase relation so as to provide a first common mode output signal, or
wherein the second partial microphone is configured to add the third diaphragm signal and the fourth diaphragm signal in the second phase relation so as to provide a second common mode output signal, or
wherein a third partial microphone is configured to add a fifth diaphragm signal and a sixth diaphragm signal in a third phase relation so as to provide a third common mode output signal, or
configured to combine the first diaphragm signal, the second diaphragm signal, the third diaphragm signal, the fourth diaphragm signal, and possibly the fifth diaphragm signal and the sixth diaphragm signal, in the first, the second, and possibly the third, phase relation so as to provide an at least partially omnidirectional or omnidirectional common mode output signal.

30. Apparatus according to claim 26, wherein the interface is configured to output or record, for each microphone system or for each microphone system except a microphone system at a middle microphone position, the pressure signal and the first differential signal, the second differential signal, and the third differential signal as a re-recorded audio piece.

31. Apparatus according to claim 26, wherein the interface is configured to output or record the pressure signal for each microphone system, and to combine at least two directional differential signals and to output a result of the combination as the differential signal derived from the directional differential signal, or to perform two different combinations to output two differential signal derived from the directional differential signals.

32. Apparatus according to claim 26, wherein a microphone position of a microphone system is arranged next to a sound transducer system of a loudspeaker system for the generation of the rotation sound field,
wherein the first partial microphone or the second partial microphone or the third partial microphone is configured to attenuate a diaphragm signal of a diaphragm directed towards a sound transducer of the sound transducer system prior to a combination with another diaphragm signal.

33. Method for re-recording an existing audio piece with a first number of channels, comprising:
reproducing the first number of channels with a first number of loudspeaker systems in a reproduction space, wherein the first number is 1 or larger than 1, or wherein the one loudspeaker system or the loudspeaker systems of the first number of loudspeaker systems is/are configured to generate, for each channel of the first number of channels, a translation sound field and a rotation sound field in the reproduction space;
recording with a second number of microphone systems arranged at different microphone positions in the reproduction space, wherein each microphone system of the second number of microphone systems is configured to capture a pressure signal and additionally a directional differential signal; and
outputting or recording the pressure signal and the directional differential signal or a differential signal derived from the directional differential signal as a re-recorded audio piece.

34. Re-recorded audio piece, comprising:
a first pressure signal, a first directional differential signal, and a second directional differential signal for a first channel; and
a second pressure signal, a third directional differential signal, and a fourth directional differential signal for a second channel.
